(19) United States
(12) Patent Application Publication
(10) Pub. No.: US 2012/0200600 A1
(43) Pub. Date: Aug. 9, 2012

(54) HEAD AND ARM DETECTION FOR VIRTUAL IMMERSION SYSTEMS AND METHODS

(76) Inventor: Kent DEMAINE, Los Angeles, CA (US)

(21) Appl. No.: 13/252,949

(22) Filed: Oct. 4, 2011

Related U.S. Application Data
(63) Continuation-in-part of application No. 13/207,312, filed on Aug. 10, 2011.
Application No. 13/207,312 is a continuation-in-part of application No. 12/823,089, filed on Jun. 24, 2010.
(60) Provisional application No. 61/389,681, filed on Oct. 4, 2010.
(60) Provisional application No. 61/357,930, filed on Jun. 23, 2010.
(60) Provisional application No. 61/372,838, filed on Aug. 11, 2010.

(51) Int. Cl. G09G 5/00; G06F 3/033

(52) U.S. Cl. 345/633

(57) ABSTRACT

Systems and methods for detection of the head and arms of a user to interact with an immersive virtual environment are disclosed. In some embodiments, a method comprises generating a virtual representation of a non-virtual environment, determining a position of a user relative to the display using an overhead sensor when the user is within a predetermined proximity to a display, determining a position of a user's head relative to the display using the overhead sensor, and displaying the virtual representation on the display in a spatial relationship with the non-virtual environment based on the position of the user's head relative to the display.

### CROSS-REFERENCE TO RELATED APPLICATION

The present application claims benefit of and seeks priority to U.S. Provisional Patent Application No. 61/389,681, filed Oct. 4, 2010, entitled “Depth-Sensing Camera from Above” which is incorporated by reference herein. The present application is also a continuation-in-part of U.S. patent application Ser. No. 13/207,312, filed Aug. 20, 2011, entitled Multi-Sensor Proximity-Based Immersion System and Method” which is a continuation-in-part of and claims benefit of U.S. patent application Ser. No. 12/823,089 filed Jun. 24, 2010, entitled “Systems and Methods for Interaction with a Virtual Environment,” which claims the benefit of the similarly entitled U.S. Provisional Patent Application No. 61/357,930 filed Jun. 23, 2010, each of which is incorporated by reference. The U.S. patent application Ser. No. 13/207,312 also claimed the benefit of U.S. Provisional Patent Application No. 61/372,838 filed Aug. 11, 2010, entitled “Multi-sensor Proximity-based Immersion System and Method,” which is incorporated by reference.

### BACKGROUND

1. Field of the Invention

The present invention generally relates to displaying of a virtual environment. More particularly, the invention relates to user interaction with a virtual environment.

2. Description of Related Art

As the prices of displays decrease, businesses are looking to interact with existing and potential client in new ways. It is not uncommon for a television or computer screen to provide consumers advertising or information in theater lobbies, airports, hotels, shopping malls and the like. As the price of computing power decreases, businesses are attempting to increase the realism of displayed content in order to attract customers.

In one example, a transparent display may be used. Computer images or CGI may be displayed on the transparent display as well. Unfortunately, the process of adding computer images or CGI to “real world” objects often appears unrealistic and creates problems of image quality, aesthetic continuity, temporal synchronization, spatial registration, focus continuity, occlusions, obstructions, collisions, reflections, shadows and refraction.

Interactions (collisions, reflections, interacting shadows, light refraction) between the physical environment/objects and virtual content is inherently problematic due to the fact the virtual content and the physical environment does not co-exist in the same space but rather they only appear to co-exist. Much work must be done to not only capture these physical world interactions but to render their influence onto the virtual content. For example, an animated object depicted on a transparent display may not be able to interact with the environment seen through the display. If the animated object does interact with the “real world” environment, then a part of that “real world” environment must also be animated and creates additional problems in synchronizing with the rest of the “real world” environment.

Transparent mixed reality displays that overlay virtual content onto the physical world suffer from the fact that the virtual content is rendered onto a display surface that is not located at the same position as the physical environment or object that is visible through the screen. As a result, the observer must either choose to focus through the display on the environment or focus on the virtual content on the display surface. This switching of focus produces an uncomfortable experience for the observer.

### SUMMARY OF THE INVENTION

Systems and methods for interaction with a virtual environment are disclosed. In some embodiments, a method comprises generating a virtual representation of a user's non-virtual environment, determining a viewpoint of a user in a non-virtual environment relative to a display, and displaying, with the display, the virtual representation in a spatial relationship with the user's non-virtual environment based on the viewpoint of the user.

In various embodiments, the method may further comprise the display relative to the user's non-virtual environment. The display may not be transparent. Further, generating the virtual representation of the user's non-virtual environment may comprise taking one or more digital photographs of the user's non-virtual environment and generating the virtual representation based on the one or more digital photographs.

A camera directed at the user may be used to determine the viewpoint of the user in the non-virtual environment relative to the display. Determining the viewpoint of the user may comprise performing facetracking of the user to determine the viewpoint.

The method may further comprise displaying virtual content within the virtual representation. The method may also further comprise displaying an interaction between the virtual content and the virtual representation. Further, the user, in some embodiments, may interact with the display to change the virtual content.

In various embodiments, the method may comprise determining a position of user relative to the display when the user is within a first proximity to the display, and determining a viewpoint of the user relative to the display when the user is within a second proximity to the display. The method may display the virtual representation based on the user viewpoint relative to the display and the user position relative to the display within or between the first and second proximities. For instance, the method may display the virtual representation of a non-virtual environment in a spatial relationship with the non-virtual environment based on the user viewpoint and the user position.

The determination of the user position may use a first sensor, while the determination of the user viewpoint may use a second sensor.

In some embodiments, the first sensor may be a proximity or position sensor that can detect a user position relative to the display, while the second sensor may be a proximity or position sensor capable of detecting a user's head position, or a camera capable of facetracking or detecting a user's head position. The first sensor, second sensor, or both may comprise a plurality of sensors.

In various embodiments, the multiple sensors used to determine the user's proximity, position and/or viewpoint relative to the display may be used to create regions of increasing immersion on a display based on the user's position, proximity or viewpoint. Additionally, with the use of two or more sensors in concert over use of a single sensor, some embodiments can: observe users around the display in greater detail (e.g., tracking body, arm, head and leg position in addition to tracking the user's face), receive higher quality sensor data (e.g., interpolate between data from multiple sensors), or provide sensor redundancy in the event that one or more of the multiple sensors ceases to operate properly (e.g., when face tracking camera fails, a position sensor can be used to detect a user's head position).

For some embodiments, the multiple sensors may be use to monitor one predefined area (i.e., zone or tracking zone) relative to the display, or used to track a number of predefined areas (i.e., multiple zones) relative to the display. In a variety of embodiments, the number of predefined areas being monitored by the multiple sensors may form a single graduated area monitored by the multiple sensors, or a blend thereof. For example, each predefined area (i.e., each zone or tracking zone) relative to the display may be monitored by a single sensor or a blend of sensors. Additionally, in some embodiments, the predefined areas may change in dimension and position relative to the display. For example, based on a given time or date where the display is located, the display may increase the size of predefined areas being monitored by the multiple sensors. For instance, for a display on a public sidewalk, the monitored area may be reposition closer to the display after 5 PM because there is more people traffic on the sidewalk and people genuinely looking at the display will tend to stand closer to the display.

An exemplary system may comprise a virtual representation module, a viewpoint module, and a display. The system may further comprise a user position module, a display position module, or a display orientation module. The virtual representation module may be configured to generate a virtual representation of a user's non-virtual environment. The viewpoint module may be configured to determine a viewpoint of a user in a non-virtual environment. The display may be configured to display the virtual representation in a spatial relationship with a user's non-virtual environment based, at least in part, on the determined viewpoint. The user position module may be used to detect a user's position relative to the display. The display position module may be used to detect the display's position relative to the non-virtual environment being represented and shown on the display. The display orientation module may be used to detect the display's orientation relative to the non-virtual environment.

An exemplary computer readable medium may be configured to store executable instructions. The instructions may be executable by a processor to perform a method. The method may comprise generating a virtual representation of a user's non-virtual environment, determining a viewpoint of a user in a non-virtual environment relative to a display, and displaying, with the display, the virtual representation in a spatial relationship with the user's non-virtual environment based on the viewpoint of the user.

Systems and methods for detection of the head and arms of a user to interact with an immersive virtual environment are also disclosed. In some embodiments, a method comprises generating a virtual representation of a non-virtual environment, determining a position of a user relative to the display using an overhead sensor when the user is within a predetermined proximity to a display, determining a position of a user's head relative to the display using the overhead sensor, and displaying the virtual representation on the display in a spatial relationship with the non-virtual environment based on the position of the user's head relative to the display.

In some embodiments, determining the position of the user's head relative to the display using an overhead sensor comprises detecting the user and determining a z-depth between the overhead camera and a position closest to the overhead sensor. The method may further comprise adding ½ of the length of an average user's head to the position closest to the overhead sensor to define a head region of interest. Moreover, the method may further comprise determining a position of the user head within the head region of interest. The method may also comprise adjusting the virtual representation to display an image over a position in the virtual representation that correlates with a position of the user's head using the head region of interest.

In various embodiments, the method further comprises detecting the user and determining a z-depth between the overhead camera and the user's arms. The method may further comprise adding a length of an average user's arms to the bottom of the z-depth between the overhead camera and the user's arms to define an arms region of interest. Moreover, the method may further comprise determining a position of a user's arms and hands in the arms region of interest. The method may also comprise adjusting the virtual representation to display an image over a position in the virtual representation that correlates with a position of the user's an us using the arms region of interest.

Determining the position of the user's head may comprise interpolating between data from the overhead sensor relating to a position of the user's head and data from the first sensor relating to the position of the user's head. In some embodiments, the overhead sensor is a camera.

An exemplary system may comprise a display, an overhead sensor, one or more display sensors, and a processor. The display may be configured to display a virtual representation of a non-virtual environment. The overhead sensor scans an area in front of the display. The one or more display sensors may be coupled to the display. The processor may be configured to determine a position of a user relative to the display using the overhead sensor when the user is within a predetermined proximity to a display, determine a position of a user's head relative to the display using the overhead sensor, and display the virtual representation on the display in a spatial relationship with the non-virtual environment based on the position of the user's head relative to the display.

An exemplary computer readable medium may be configured to store executable instructions. The instructions may be executable by a processor to perform a method. The method may comprise generating a virtual representation of a non-virtual environment, determining a position of a user relative to the display using an overhead sensor when the user is within a predetermined proximity to a display, determining a position of a user's head relative to the display using the overhead sensor, and displaying the virtual representation on the display in a spatial relationship with the non-virtual environment based on the position of the user's head relative to the display.

### BRIEF DESCRIPTION OF THE DRAWINGS

FIG. 1 is an environment for practicing various exemplary systems and methods.

FIG. 2 depicts a window effect on a non-transparent display in some embodiments.

FIG. 3 depicts a window effect on a non-transparent display in some embodiments.

FIG. 4 is a box diagram of an exemplary digital device in some embodiments.

FIG. 5 is a flowchart of a method for preparation of the virtual representation, virtual content, and the display in some embodiments.

FIG. 6 is a flowchart of a method for displaying the virtual representation and virtual content in some embodiments.

FIG. 7 is a flowchart of a method for using multiple sensors and user proximity to display the virtual representation and virtual content in some embodiments.

FIG. 8 is a flowchart of a method for using multiple sensors and user proximity to display the virtual representation and virtual content in some embodiments.

FIGS. 9A-C are diagrams of an exemplary non-transparent display in some embodiments.

FIG. 10 depicts a window effect on a non-transparent display in some embodiments.

FIG. 11 depicts a window effect on layered non-transparent displays in some embodiments.

FIG. 12 is a block diagram of an exemplary digital device in some embodiments.

FIG. 13 depicts a window effect on a non-transparent display in some embodiments.

FIGS. 14A and 14B depict a head region of interest and an arms region of interest of a user in some embodiments.

FIGS. 15A and 15B depict an area in front of a display comprising three sensors and three tracking zones in some embodiments.

FIG. 16 is a flowchart of a method for determining a position of a user's head and arms in some embodiments.

### DETAILED DESCRIPTION OF THE INVENTION

Exemplary systems and methods described herein allow for user interaction with a virtual environment. In various embodiments, a display may be placed within a user's non-virtual environment. The display may depict a virtual representation of at least a part of the user's non-virtual environment. The virtual representation may be spatially aligned with the user's non-virtual environment such that the user may perceive the virtual representation as being a part of the user's non-virtual environment. For example, the user may see the display as a window through which the user may perceive the non-virtual environment on the other side of the display. The user may also view and/or interact with virtual content depicted by the display that is not a part of the non-virtual environment. As a result, the user may interact with an immersive virtual reality that extends and/or augments the non-virtual environment.

In one exemplary system, a virtual representation of a physical space (i.e., a “real world” environment) is constructed. Virtual content that is not a part of the actual physical space may also be generated. The virtual content may be displayed in conjunction with the virtual representation. After at least some of the virtual representation of the physical space is generated, a physical display or monitor may be placed within the physical space. The display may be used to display the virtual representation in a spatial relationship with the physical space such that the content of the display may appear to be a part of the physical space.

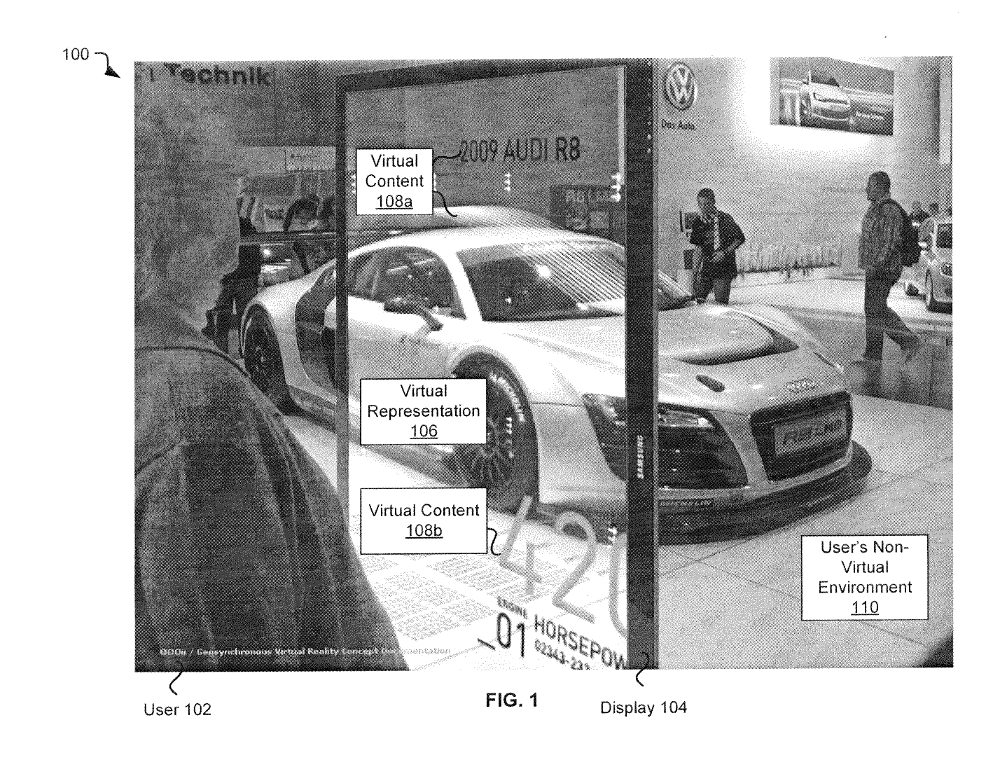

FIG. 1 is an environment 100 for practicing various exemplary systems and methods. In FIG. 1, the user 102 is within the user's non-virtual environment 110 viewing a display 104. The user's non-virtual environment 110, in this figure, is a show room floor of a Volkswagen dealership. Behind the display 104 in the user's non-virtual environment 110, from the user's perspective, is a 2009 Audi® R8 automobile.

The display 104 depicts a virtual representation 106 of the user's non-virtual environment 110 as well as additional virtual content 108a and 108b. The display 104 displays a virtual representation 106 of at least a part of what is behind the display 104. In this figure, the display 104 displays a virtual representation of part of the 2009 Audi R8 automobile. In various embodiments, the display 104 is opaque (e.g., similar to a standard computer monitor) and displays a virtual reality (i.e., a virtual representation 106) of a non-virtual environment (i.e., the user's non-virtual environment 110). The display of the virtual representation 106 may be spatially aligned with the non-virtual environment 110. As a result, all or portions of the display 104 may appear to be transparent from the perspective of the user 104.

The display 104 may be of any size including 50 inches or larger. Further, the display may display the virtual representation 106 and/or the virtual content 108a and 108b at any frame rate including 15 frames a second or 30 frames a second.

Virtual reality is a computer-simulated environment. The virtual representation is a virtual reality of an actual non-virtual environment. In some embodiments, the virtual representation may be displayed on any device configured to display information. In some examples, the virtual representation may be displayed through a computer screen or stereoscopic displays. The virtual representation may also comprise additional sensory information such as sound (e.g., through speakers or headphones) and/or tactile information (e.g., force feedback) through a haptic system.

In some embodiments, all or a part of the display 104 may spatially register and track all or a portion of the non-virtual environment 110 behind the display 104. This information may then be used to match (e.g., in position, size, and appearance) and spatially align the virtual representation 106 with the non-virtual environment 110.

In some embodiments, virtual content 108a-b may appear within the virtual representation 106. Virtual content is computer-simulated and, unlike the virtual representation of the non-virtual environment, may depict objects, artifacts, images, or other content that does not exist in the area directly behind the display within the non-virtual environment. For example, the virtual content 108a is the words “2009 Audi R8” which may identify the automobile that is present behind the display 104 in the user's non-virtual environment 110 and that is depicted in the virtual representation 106. The words “2009 Audi R8” do not exist behind the display 104 in the user's non-virtual environment 110 (e.g., the user 104 may not peer behind the display 104 and see the words “2009 Audi R8”). Virtual content 108a also comprises wind lines that sweep over the virtual representation 106 of the automobile. The wind lines may depict how air may flow over the automobile while driving. Virtual content 108b comprises the words “420 engine HORSEPOWER_{—}01 02343-232” which may indicate that the engine of the automobile has 420 horsepower. The remaining numbers may identify the automobile, identify the virtual representation 106, or indicate any other information.

Those skilled in the art will appreciate that the virtual content may be static or dynamic. For example, the virtual content 108a statically depict the words “2009 Audi R8.” In other words, the words may not move or change in the virtual representation 106. The virtual content 108a may also comprise dynamic elements such as the wind lines which may move by appearing to sweep air over the automobile. More or less wind lines may also be depicted at any time.

The virtual content 108a may also interact with the virtual representation 106. For example, the wind lines may touch the automobile in the virtual representation 106. Further, a bird or other animal may be depicted as interacting with the automobile (e.g., landing on the automobile or being within the automobile). Further, virtual content 108a may depict changes to the automobile in the virtual representation 106 such as opening the hood of the automobile to display an engine or opening a door to see the content of the automobile. Since the display 104 depicts a virtual representation 106 and is not transparent, virtual content may be used to change the display, alter, or interact with all or part of the virtual representation 106 in many ways.

Those skilled in the art will appreciate that it may be very difficult for virtual content to interact with objects that appear in a transparent display. For example, a display may be transparent and show the automobile through the display. The display may attempt to show a virtual bird landing on the automobile. In order to realistically show the interaction between the bird and the automobile, a portion of the automobile must be digitally rendered and altered as needed (e.g., in order to show the change in light on the surface of the automobile as the bird approaches and lands, to show reflections, and to show the overlay to make the image appear as if the bird has landed.) In some embodiments, a virtual representation of the non-virtual environment allows for generation and interaction of any virtual content within the virtual representation without these difficulties.

In some embodiments, all or a part of the virtual representation 106 may be altered. For example, the background and foreground of the automobile in the virtual representation 106 may change to depict the automobile in a different place and/or driving. The display 104, for example, may display the automobile at scenic places (e.g., Yellowstone National Park, Lake Tahoe, on a mountain top, or on the beach) The display 104 may also display the automobile in any conditions and or in any light (e.g., at night, in rain, in snow, or on ice).

The display 104 may display the automobile driving. For example, the automobile may be depicted as driving down a country road, off road, or in the city. In some embodiments, the spatial relationship (i.e., spatial alignment) between the virtual representation 106 of the automobile and the actual automobile in the non-virtual environment 110 may be maintained even if any amount of virtual content changes. In other embodiments, the automobile may not maintain the spatial relationship between the virtual representation 106 of the automobile and the actual automobile. For example, the virtual content may depict the virtual representation 106 of the automobile “breaking away” from the non-virtual environment 110 and moving, shifting, or driving to or within another location. In this example, the all or a portion of the automobile may be depicted by the display 104. Those skilled in the art will appreciate that the virtual content and virtual representation 106 may interact in any number of ways.

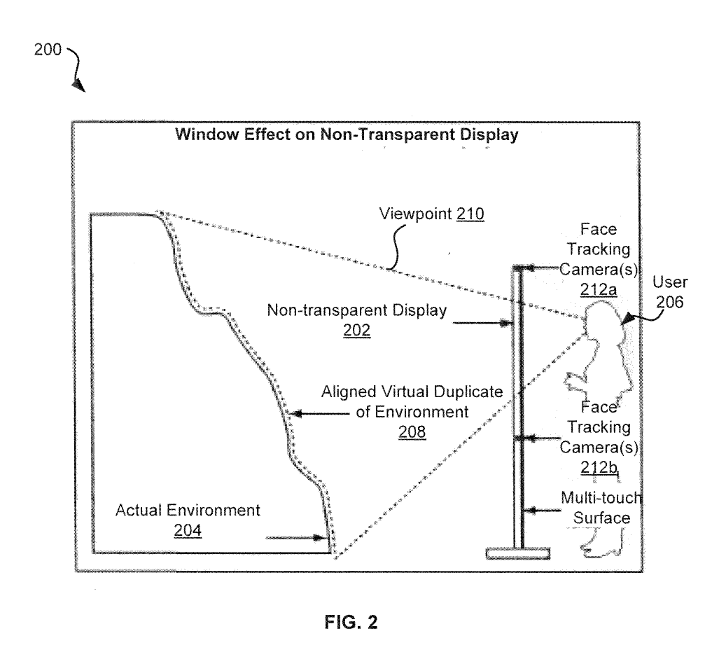

FIG. 2 depicts a window effect on a non-transparent display 200 in some embodiments. FIG. 2 comprises a non-transparent display 202 between an actual environment 204 (i.e., the user's non-virtual environment) and the user 206. The user 206 may view the display 202 and perceive an aligned virtual duplicate of the actual environment 208 (i.e., a virtual representation of the user's non-virtual environment) behind the display 202 opposite the user 206. The virtual duplicate of the actual environment 208 is aligned with the actual environment 204 such that the user 206 may perceive the display 202 as being partially or completely transparent.

In some embodiments, the user 206 views the content of the display 202 as part of an immersive virtual reality experience. For example, the user 206 may observe the virtual duplicate of the environment 208 as a part of the actual environment 204. Virtual content may be added to the virtual duplicate of the environment 208 to add information (e.g., directions, text, and/or images).

The display 202 may be any display of any size and resolution. In some embodiments, the display is equal to or greater than 50 inches and has a high definition resolution (e.g., 1920×1080). In some embodiments, the display 202 is a flat panel LED backlight display.

Virtual content may also be used to change the virtual duplicate of the environment 208 such that the changes occurring in the virtual duplicate of the environment 208 appear to the user as happening in the actual environment 204. For example, a user 206 may enter a movie theater and view the movie theater through the display 202. The display 202 may represent a virtual duplicate of the environment 208 by depicting a virtual representation of a concession stand behind the display 202 (e.g., in the actual environment 204). The display 202, upon detection or interaction with the user, may depict a movie character or actor walking and interacting within the virtual duplicate of the environment 208. For example, the display 202 may display Angelina Jolie purchasing popcorn even if Ms. Jolie is not actually present in the actual environment 204. The display 202 may also display the concession stand being destroyed by a movie character (e.g., Iron Man from the Iron Man movie destroying the concession stand). Those skilled in the art will appreciate that the virtual content may be used in many ways to impressively advertise, provide information, and/or provide entertainment to the user 206.

In various embodiments, the display 202 may also comprise one or more face tracking cameras 212a and 212b to track the user 206, the user's face, and/or the user's eyes to determine a user's viewpoint 210. In additional embodiments, the user's viewpoint 210 may also be determined using a proximity or position sensor configured to determine the user's head position; such a proximity or position sensor may operate in place of, or in concert with, face tracking camera 212a and/or 212b. Those skilled in the art will appreciate that the user's viewpoint 210 may be determined in any number of ways. Once the user's viewpoint 210 is determined, the spatial alignment of the virtual duplicate of environment 208 may be changed and/or defined based, at least in part, on the viewpoint 210. In one example, the display 202 may display and/or render the virtual representation from the optical viewpoint of the observer (e.g., the absolute or approximate position/orientation of the user's eyes).

In one example, the display 202 may detect the presence of a user (e.g., via a camera, a light sensor, a motion sensor, a proximity sensor, or position sensor disposed on or with the display). The display 202 may display the virtual duplicate of environment to the user 206. Either immediately or subsequent to determination of the viewpoint 210 of the user 206, the display may define or adjust the alignment of the virtual duplicate of the environment 208 to more closely match what the user 206 would perceive of the actual environment 204 behind the display 202. The alteration of the spatial relationship between the virtual duplicate of the environment 208 and the actual environment 204 may allow for the user 206 to have an enhanced (e.g., immersive and/or augmented) experience wherein the virtual duplicate of the environment 208 appears to be the actual environment 204. For example, much like a person looking out of one side of a window (e.g., the left side of the window) and perceiving more of the environment on the other side of the window, a user 206 standing to one side of the display 202 may perceive more on one side of the virtual duplicate of environment 208 and less on the other side of the virtual duplicate of the environment 208.

In additional embodiments, display 202 may also comprise one or more proximity or position sensors (not shown) that monitor the user 206 and detect the user's proximity or position relative to the display 202. With this user proximity or position information proximity or position information may be used to align the virtual duplicate of environment 208 with the actual environment 204. Further, proximity or position information may be used in conjunction with face tracking information to refine the alignment of the virtual duplicate of environment 208 with the actual environment 204. In cases where the proximity or position sensor is working in concert with one or more face tracking cameras 212a and/or 212b, the proximity or position sensor may (by detecting the user's head position) may be used to in determining the user's viewpoint 210 when the face tracking cameras are malfunctioning, or when the user 206 is out of range of the face tracking cameras but in range of the proximity or position sensor.

In some embodiments, the display 202 may continuously align the virtual representation with the non-virtual environment at predetermined intervals. For example, the predetermined intervals may be equal to or greater than 15 frame per second. The predetermined interval may be any amount.

The virtual content may also be interactive with the user 206. In one example, the display 202 may comprise a touch surface, such as a multi-touch surface, allowing the user to interact with the display 202 and/or the virtual content. For example, virtual content may display a menu allowing the user to select an option or request information by touching the screen. The user 206, in some embodiments, may also move virtual content by touching the display and “pushing” the virtual content from one portion of the display 202 to another. Those skilled in the art will appreciate that the user 206 may interact with the display 202 and/or the virtual content in any number of ways.

The virtual representation and/or the virtual content may be three dimensional. In some embodiments, the three dimensional virtual representation and/or virtual content rendered on the display 202 allows for the perception that the virtual content co-exists with the actual physical environment when in fact, all content on the display 202 may be rendered from one or more 3D graphics engines. The 3D replica of the surrounding physical environment can be created or acquired through either traditional 3D computer graphic techniques or by extrapolating 2D video into 3D space using computer vision or stereo photography techniques. Each of these techniques is not exclusive and therefore they can be used together to replicate all or a portion of an environment. In some instances, multiple video inputs can be used in order to more fully render the 3D geometry and textures.

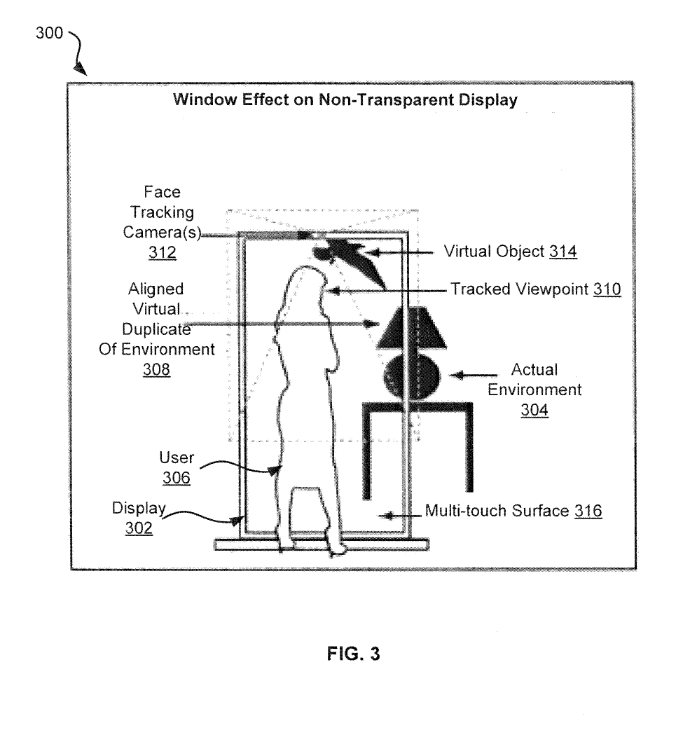

FIG. 3 depicts a window effect on a non-transparent display 300 in some embodiments. FIG. 3 comprises a display 302 between an actual environment 304 (i.e., the user's non-virtual environment) and the user 306. The user 306 may view the display 302 and perceive an aligned virtual duplicate of the actual environment 308 (i.e., a virtual representation of the user's non-virtual environment) behind the display 302. The virtual duplicate of the actual environment 308 is aligned with the actual environment 304 such that the user 306 may perceive the display 302 as being partially or completely transparent. For example, a lamp in the actual environment 304 may be partially behind the display 304 from the user's perspective. A portion of the physical lamp may be viewable by the user 306 as being to the right side of the display 302. The obscured portion of the lamp, however, may be virtually depicted within the virtual duplicate of the environment 308. The virtually depicted portion of the lamp may be aligned with the visible portion of the lamp in the actual environment 304 such that the virtual portion and the visible portion of the lamp appear to be parts of the same physical lamp in the actual environment 304.

The alignment between the virtual duplicate of the environment 308 and the actual environment 304 may be based on the viewpoint of the user 306. In some embodiments, the viewpoint of the user 306 may be tracked. For example, the display may comprise or be coupled to one or more face tracking camera(s) 312. The camera(s) 312 may face the user and/or a front portion of the display 302. The camera(s) may be used to determine the viewpoint of the user 306 (i.e., used to determine the tracked viewpoint 310 of the user 306). The camera(s) may be any cameras, including, but not limited to, PS3 Eye or Point Grey® Firefly® models.

The camera(s) may also detect the proximity of the user 306 to the display 302. The display may then align or realign the virtual representation (i.e., the virtual duplicate of environment 308) with the non-virtual environment (i.e., actual environment 304) based, at least in part, on a viewpoint from a user 306 standing at that proximity. For example, a user 302 standing a distance of ten feet or more from the display 302 would perceive less detail of the non-virtual environment. As a result, after detecting a user 306 at ten feet, the display 302 may either generate or spatially align the virtual duplicate of the environment 308 with the actual environment 304 from the user's perspective based, in part, on the user's proximity and/or viewpoint.

Although FIG. 3 identifies the camera(s) 312 as “face tracking,” the camera(s) 312 may not track the face of the user 306. For example, the camera(s) 312 may detect the presence and/or general position of the user. Although not shown, the display 302 may also include one or more proximity or position sensors configured to detect the presence or position of the user 306. The proximity or position sensors may be in addition to, or may take the place of, the camera(s) 312.

Any information may be used to determine the viewpoint of the user 306. In some embodiments, camera(s) may detect the face, eyes, or general orientation of the user 306. In additional embodiments, proximity or position sensors may detect the head position or the body orientation of the user 306. Those skilled in the art will appreciate that tracking the viewpoint of the user 306 may be an approximation of the actual viewpoint of the user.

In some embodiments, the display 302 may display virtual content, such as virtual object 314, to the user 306. In one example, the virtual object 314 is a bird in flight. The bird may not exist in the actual environment 304 as can be seen in FIG. 3 with the wing of the virtual object 314 extending off the top of the display 302 but not appearing above the display 302 in the actual environment 304. In various embodiments, the display of virtual content may depend, in part, on the viewpoint, proximity, and/or position of the user 306. For example, if a user 306 stands in close proximity with the display 302, the virtual object 314 may be depicted larger, in different light, and/or in more detail (e.g., increased detail of the feathers of the bird) than if the user 306 stands at a distance (e.g., 15 feet) from the display 302. In various embodiments, the display 302 may display the degree of size, light, texture, and/or detail of the bird based, in part, on the proximity and/or viewpoint of the user 306. The proximity, position and/or viewpoint of the user 306 may be detected by any type of device including, but not limited to, camera(s), light detectors, radar, laser ranging, motion sensors or the like.

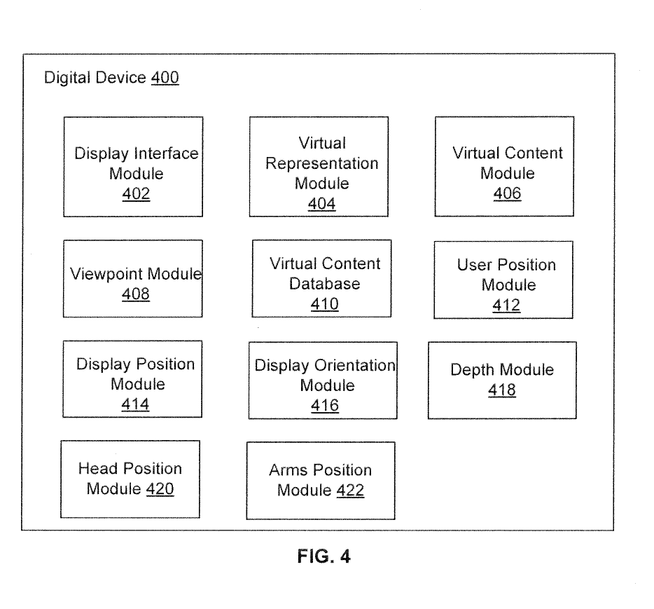

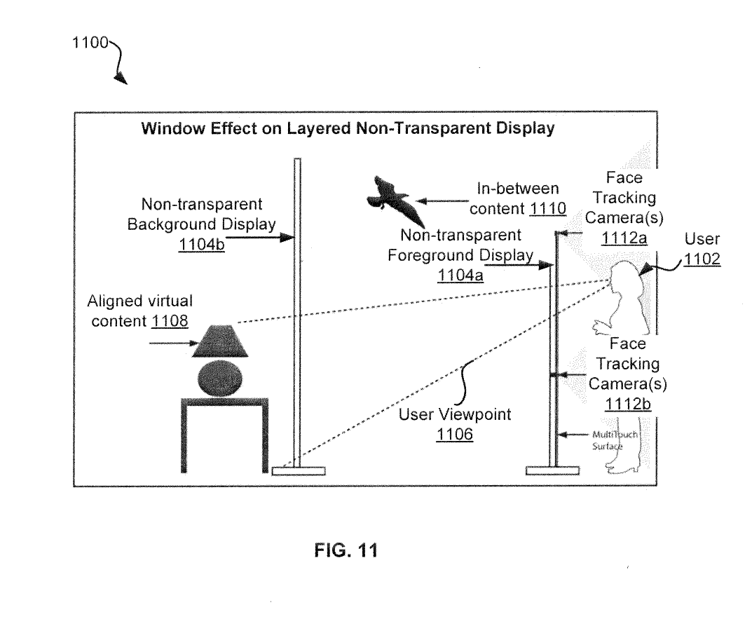

FIG. 4 is a box diagram of an exemplary digital device 400 in some embodiments. A digital device 400 is any device with a processor and memory. In some examples, a digital device may be a computer, laptop, digital phone, smart phone (e.g., iPhone or M1), netbook, personal digital assistants, set top box (e.g., satellite, cable, terrestrial, and IPTV), digital recorder (e.g., Tivo DVR), game console (e.g., Xbox), or the like. Digital devices are further discussed with regard to FIG. 11.

In various embodiments, the digital device 400 may be coupled to the display 302. For example, the digital device 400 may be coupled to the display 302 with one or more wires (e.g., video cable, Ethernet cable, USB, HDMI, displayport, component, RCA, or Firewire) or be wirelessly coupled to the display 302. In some embodiments, the display 302 may comprise the digital device 400 (e.g., all or a part of the digital device 400 may be a part of the display 302).

The digital device 400 may comprise a display interface module 402, a virtual representation module 404, a virtual content module 406, a viewpoint module 408, a virtual content database 410, a user position module 412, a display position module 414, a display orientation module 416, a depth module 418, a head position module 420, and a body position module 422. A module may comprise, individually or in combination, software, hardware, firmware, or circuitry.

The display interface module 402 may be configured to communicate and/or control the display 302. In various embodiments, the digital device 400 may drive the display 302. For example, the display interface module 402 may comprise drivers configured to display the virtual environment and virtual content on the display 302. In some embodiments, the display interface module comprises a video board and/or other hardware that may be used to drive and/or control the display 302.

In some embodiments, the display interface module 402 also comprises interfaces for different types of input devices. For example, the display interface module 402 may be configured to receive signals from a mouse, keyboard, scanner, camera, haptic feedback device, audio device, or any other device. In various embodiments, the digital device 400 may alter or generate virtual content based on the input from the display interface module 402 as discussed herein.

In various embodiments, the display interface module 402 may be configured to display 3D images on the display 302 with or without special eyewear (e.g., tracking through use of a marker). In one example, the virtual representation and/or virtual content generated by the digital device 400 may be displayed on the display as 3D images which may be perceived by the user.

The virtual representation module 404 may generate the virtual representation. In various embodiments, a dynamic environment map of the non-virtual environment may be captured using a video camera with wide-angle lens or video camera aiming at spherical mirrored ball, this enables lighting, reflections, refraction and screen brightness to incorporate changes in the actual physical environment. Further, dynamic object position and orientation may be obtained through tracking markers and/or sensors which may capture the position and/or orientation of objects in the non-virtual world, such as a dynamic display location or dynamic physical object location, so that such objects can be properly incorporated into the rendering of the virtual representation.

Further, programmers may use digital photographs of the non-virtual environment to generate the virtual representation. Applications may also receive digital photographs from digital cameras or scanners and generate all or some of the virtual reality. In some embodiments, one or more programmers code the virtual representation including, in some examples, lighting, textures, and the like. In conjunctions with or in place of programmers, applications may be used to automate some or all of the process of generating the virtual representation. The virtual representation module 404 may generate and display the virtual representation on the display via the display interface module 402.

In some embodiments, the virtual representation is lighted using an approximation of light sources in the related non-virtual environment. Similarly, shading and shadows may appear in the virtual representation in a manner similar to the shading and shadows that may appear in the related non-virtual environment.

The virtual content module 406 may generate the virtual content that may be displayed in conjunction with the virtual representation. In various embodiments, programmers and/or applications generate the virtual content. Virtual content may be generated or added that alters the virtual representation in many ways. Virtual content may be used to change or add shading, shadows, lighting, or any part of the virtual representation. The virtual content module 406 may create, display, and/or generate virtual content.

The virtual content module 406 may also receive an indication of an interaction from the user and respond to the interaction. In one example, the virtual content module 406 may detect an interaction with the user (e.g., via a touchscreen, keyboard, mouse, joystick, gesture, or verbal command). The virtual content module 406 may then respond by altering, adding, or removing virtual content. For example, the virtual content module 406 may display a menu as well as menu options. Upon receiving an indication of an interaction from a user, the virtual content module 406 may perform a function and/or alter the display.

In one example, the virtual content module 406 may be configured to detect an interaction with a user through a gesture based system. In some embodiments, the virtual content module 406 comprises one or more cameras that observe one or more users. Based on the user's gestures, the virtual content module 406 may add virtual content to the virtual representation. For example, at a movie theater, the user may view a virtual representation of the theater lobby in the user's non-virtual environment. Upon receiving an indication from the user, the virtual content module 406 may change the perspective of the virtual representation such that the user views the virtual representation as if the user was a movie character such as Iron Man. The user may then interact with the virtual representation and virtual content through gesture or other input. For example, the user may blast the virtual representation of the theater lobby with repulsors in Iron Man's gauntlets as if the user was Iron Man. The virtual content may alter the virtual representation to make the virtual representation of the theater lobby appear to be damaged or destroyed. Those skilled in the art will appreciate that the virtual content module 406 may add or remove virtual content in any number of ways.

In various embodiments, the virtual content module 406 may depict a “real” or non-virtual object, such as an animal, vehicle, or any object within or interacting with the actual representation. The virtual content module 406 may replicate light and/or shadow effects of the virtual object passing between a light and any part of the virtual representation. In one example, the shape of the object (i.e., the occluding object) may be calculated by the virtual content module 406 using a real-time z-depth matte generated from computer vision analysis of stereo cameras or input from a time of flight laser scanning camera.

The virtual content module 406 may also add reflections. In one example, the virtual content module 406 extracts a foreground object, such as a user in front of the display, from a video (e.g., taken by one or more forward facing camera(s)) using a real-time z-depth matte and incorporates this imagery into a real-time reflection/environment map to be used within and in conjunction with the virtual representation.

The virtual content module 406 may render the virtual content with the non-virtual environment in all three dimensions. To this end, the virtual content module 406 may apply z-depth natural occlusions to virtual content in a manner visually consistent with their physical counterparts. If a physical object passes between another physical object and the viewer, the physical object and its virtual counterpart may occlude or appear to pass in front of the more distant object and its virtual counterpart.

In some embodiments, the physical display may use a 3D rendering strategy that can reproduce the optical lens distortions of the human vision system. In one example, the virtual representation module 404 and/or the virtual content module 406 utilize how light is bent while traveling through curved lens (e.g., through the pupil (aperture)) and rendered onto the retina may be virtually simulated utilizing 3D spatial and optical distortion algorithms.

The viewpoint module 408 may be configured to detect and/or determine the viewpoint of a user. As discussed herein, the viewpoint module 408 may comprise or receive signals from one or more camera(s), light detector(s), laser range detector(s), and/or other sensor(s). In some embodiments, the viewpoint module 408 determines the viewpoint by detecting the presence of a user in a proximity to the display. In one example, the viewpoint may be fixed for users within a certain range of the display. In other embodiments, the viewpoint module 408 may determine the viewpoint through the position of the user, the proximity of the user to the display, facetracking, eyetracking, or any technique. The viewpoint module 408 may then determine the likely or approximate viewpoint of the user. Based on the viewpoint determined by the viewpoint module 408, the virtual representation module 404 and/or the virtual content module 406 may alter or align the virtual representation and virtual content so that the virtual representation is spatially aligned with the non-virtual environment from the perspective of the user.

In one example, a user in close in perpendicular proximity to a display may increase the viewing angle into the virtual representation and conversely, the user moving away may decrease the viewing angle. Because of this, the computational requirements on the virtual representation module 404 and/or the virtual content module 406 may be greater for wider viewing angles. In order to manage these additional requirements in a manner that has less impact to the viewing experience, the virtual representation module 404 and/or the virtual content module 406 may employ an optimization strategy based on the characteristics of the human vision system. An optimization strategy, based on a conical degradation of visual complexity which mimics the degradation in the human visual periphery resulting from the circular degradation of receptors on the retina, may be employed to manage the dynamic complexity of the rendered content within any given scene. Content that appears closest to the viewing axis (a normal extending perpendicular to the eyes of the viewer) may be rendered with greatest complexity/level of detail then, in progressive steps, the complexity/level of detail may decrease as the distance from the viewing axis increases. By dynamically managing this degradation of complexity, the virtual representation module 404 and/or the virtual content module 406 may be able to maintain a visual continuity across both narrow and wide viewing angles.

In some embodiments, once a position of a face tracking cameras is established, an extrapolated 3D center point along with a video composite of camera images may be sent to the viewpoint module 408 for real-time evaluation. Utilizing computer vision techniques, the viewpoint module 408 may determine values for the 3D position and 3D orientation of the user's face relative to the 3D center point. These values may be considered the raw location of the viewer's viewpoint/eyes and may be passed through to a graphics engine (e.g., the virtual representation module 404 and/or the virtual content module 406) to establish the 3D position of the virtual viewpoint from which all or a part of the virtual representation and/or virtual content is rendered. In some embodiments, eyewear may be worn by the user to assist in the face tracking and creating the view point.

Those skilled in the art will appreciate that the viewpoint module 408 may continue to detect changes in the viewpoint of the user based on changes in position, proximity, face direction, eye direction, or the like. In response to changes in viewpoint, the virtual representation module 404 and the virtual content module 406 may change the virtual representation and/or virtual content.

The user position module 412 may be configured to detect and/or determine the position or proximity of the user to the display. The user position module 412 may comprise or receive signals from one or more sensors, including camera(s), light detector(s), laser range detector(s), motion sensors, proximity sensors, position sensors, and/or other sensor(s). According to some embodiments, the user position module 412 determines the position of the user to the display by detecting the proximity of the user to the display. In some embodiments, when two or more users are viewing the display, the user position module 412 can be used to determine which user's viewpoint the display will use to display the virtual representation. For example, where two users (a first user and a second user) are viewing the display, the user position module 412 may determine that the first user is closest to the display and as such, the display should display the virtual representation based on the viewpoint of the first user rather than the viewpoint of the second user. In some embodiments, an average, such as a mean, may be taken to present the virtual representation based on a viewpoint between the position of the users.

In various embodiments, the user position module 412 may detect more than a user's general position. For example, in some embodiments, the user position module 412 may detect a user's head position, leg position, or arm position. With the head position data, some embodiments may, for example, augment the face tracking information obtained by the viewpoint module 408 and used in determining a user's viewpoint. In other instances, when face tracking information from a camera is determined to be unreliable or unavailable, the viewpoint module 408 may use the user's head position as an alternative to face tracking information in determining the user's viewpoint. Some embodiments may use the user's leg position or arm position to detect the user's particular physical actions (e.g., the user is waving), which can be used by digital device 400 as a form of interactive input by the user.

By tracking a user's proximity or position relative to the display over a period of time, the user position module 412 may determine a user's rate of approach toward the display. Subsequently, some embodiments may use the user's rate of approach when displaying the virtual representation or when displaying virtual content in the virtual representation. For instance, the user's rate of approach may be used by the digital device 400 to determine and/or adjust the rate at which the virtual representation should be refreshed or changed (e.g., adjustment of alignment) in order to keep pace with the user's rate of approach. In another example, if a user was approaching the display at rate deemed to be unsafe, the display may change the virtual content to flash a warning on the display to avert the user from colliding with the display.

The display position module 414 may be configured to detect the display's position with respect to the non-virtual environment. Similarly, the display orientation module 416 may be configured to detect the display's orientation with respect to the non-virtual environment. Various embodiments may utilize the display's position and/or orientation with respect to the non-virtual environment when displaying the virtual representation in a spatial relationship with the non-virtual environment. For example, if the display is repositioned within the non-virtual environment, or the display is reoriented such that the back of the display pointed elsewhere in the non-virtual environment, the digital device 400 may detect such changes and spatially realign the virtual representation with the non-virtual environment such that a user continues to perceive a virtual duplicate of the non-virtual environment behind the display on the display.

In some embodiments, the display position module 414 may comprise or receive signals from a GPS component, laser range detector(s), and/or other sensor(s) to determine the display's position relative to the non-virtual environment. In various embodiments, the display orientation module 416 may comprise or receive signals from accelerometer(s), gyroscope(s), and/or other sensor(s) to determine the display's orientation relative to the non-virtual environment.

In various embodiments, the virtual representation module 404 and/or the virtual content module 406 may generate one or more images in three dimensions (e.g., spatially registering and coordinating the virtual representation and/or the virtual content's 3D position, orientation) and scale. All or part of the virtual world, including both the virtual representation and the virtual content, may be presented in full scale and may relate to human size.

The depth module 418 is configured to determine a position of a user relative to the display. In various embodiments, the depth module 418 includes or is in communication with one or more overhead sensors. The one or more overhead sensors may include, but are not be limited to, a light sensor, a laser range detector, a motion sensor, a proximity sensor, a position sensor, and/or another kind of sensor. The overhead sensors may be positioned over an area in front of the digital device 400 and/or display. Further, the overhead sensor may sense movement or a position of an object between the overhead sensors and the ground. The overhead sensors may provide the information to the depth module 418 which may determine a user's position relative to the digital device 400 and/or display.

In some embodiments, the depth module 418 is configured to determine one or more users' positions relative to the display, including the distance from the display, direction of the users' movements, and rate of approach. As discussed herein, the depth module 418 may determine the position of one or more users relative to predetermined zones. In one example, the virtual representation may respond to one or more users' presence and position based on predetermined zones.

The head position module 420 may be configured to determine a head region of interest relative to the user and/or a position of a user's head. In one example, the overhead sensor may detect a point of an object that is closest to the overhead sensor. The overhead sensor and/or the head position module 420 may determine that the object that is closest to the overhead sensor is a head of a user. In some embodiments, the overhead sensor and/or the head position module 420 is configured to perform image recognition, blob detection, and/or z-depth analysis to determine if the object in question is sufficiently high from the ground, at a sufficient distance from the overhead sensor, or appears to be similar to a user's head.

In some embodiments, the overhead sensor and/or the head position module 420 may detect the tallest point of the user's head (e.g., the point closest to the overhead sensor) and extend from that position down a distance towards the floor to define a head region of interest. The distance from the tallest point may be an average length of a person's head or a portion of the average length of a person's head (e.g., one-half). In one example, a user approaches the digital device 400. The overhead sensor may detect the user, the user's position relative to the display, rate of approach, and the point if the user's body that is closest to the overhead sensor. The overhead sensor and/or the head position module 420 may then extend that point closest to the overhead sensor downward to define a head region of interest.

Those skilled in the art will appreciate that other sensors may be used in conjunction with the overhead sensor. In one example, once the head region of interest is defined, one or more sensors coupled to the digital device 500 may focus on an area within the head region of interest as defined using the head position module 420, to determine a viewpoint.

In some embodiments, the head position module 420, in conjunction with an overhead sensor and/or other sensors, perform blob detection using the head region of interest to calculate and predict a position of the user's head relative to the display surface, and then calculate a position of the user's head.

The body position module 422 may be configured to determine an arms region of interest relative to the user. In one example, the overhead sensor may detect a point of an object that is below the head region of interest. For example, the overhead sensor may detect a position of an object that is closest to the overhead camera. The head position module 420 may define a head region of interest as between the position of the object closest to the overhead camera and a position that is a predetermined length below the position of the object closest to the overhead camera. The body position module 422 may define an arms region of interest as between the bottom of the head region of interest and a position below the bottom of the head region of interest (e.g., an average user's arm length or a portion of an average user's arm length below the bottom of the head region of interest). The body position module 422 may also scan and identify movements of arms and hands to make corrections for the aims region of interest.

The arms region of interest may extend in front of the user and slightly towards the user's back. For example, the arms region of interest may include the position of the user's body and an average arm length in front of the user.

In some embodiments, the body position module 422, in conjunction with an overhead sensor and/or other sensors, perform blog detection using the arms region of interest to calculate and predict a position of the user's arms and/or hands relative to the display surface, and then calculate a position of the user's arms and/or hands.

Those skilled in the art will appreciate that other sensors may be used in conjunction with the overhead sensor. In one example, once the arms region of interest is defined, one or more sensors coupled to the digital device 500 may focus on an area within the arms region of interest, as defined using the body position module 420, to determine a position of the user's arms and/or hands. The sensors, alone or in combination, may detect arm and/or hand motion.

In some embodiments, using the overhead sensor, the virtual representation may change based on the head region of interest or the arm region of interest. In one example, the virtual representation may show the user as Iron Man. The helmet of the Iron Man representation may be generated in a position that is relative to the user's head in front of the display. Further, the armored arms may also be generated in a position that is relative to the user's arms. As the user moves his arms, the Iron Man virtual representation may similarly move. Movements and positions of the head, arms, legs, and/or body of the virtual representation may approximate the movements and positions of the head, arms, legs, and/or body of the user relative to the display.

The virtual content database 410 is any data structure that is configured to store all or part of the virtual representation and/or virtual content. The virtual content database 410 may comprise a computer readable medium as discussed herein. In some embodiments, the virtual content database 410 stores executable instructions (e.g., programming code) that is configured to generate all or some of the virtual representation and/or all or some of the virtual content. The virtual content database 410 may be a single database or any number of databases. The databases(s) of the virtual content database 410 may be within any number of digital devices 400. In some embodiments, different executable instructions stored in the virtual content database 410 performs different functions. For example, some of the executable instructions may shade, add texturing, and/or add lighting to the virtual representation and/or virtual content.

Although a single digital device 400 is show in FIG. 4, those skilled in the art will appreciate that any number of digital devices may be in communication with any number of displays. In one example, three different digital devices 400 may be involved in displaying the virtual representation and/or virtual content of a single display. The digital devices 400 may be directly coupled to the display and/or each other. In other embodiments, the digital devices 400 may be in communication with the display and/or each other through a network. The network may be a wired network, a wireless network, or both.

It should be noted that FIG. 4 is exemplary. Alternative embodiments may comprise more, less, or functionally equivalent modules and still be within the scope of present embodiments. For example, the functions of the virtual representation module 404 may be combined with the function of the virtual content module 406. Those skilled in the art will appreciate that there may be any number of modules within the digital device 400.

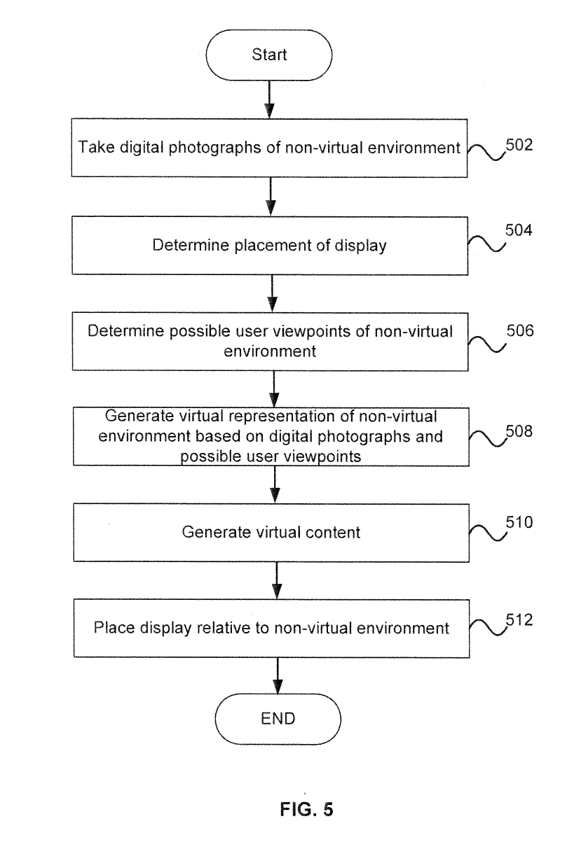

FIG. 5 is a flowchart of a method for preparation of the virtual representation, virtual content, and the display in some embodiments. In step 502, information regarding the non-virtual environment is received. In some embodiments, the virtual representation module 404 receives the information in the form of digital photographs, digital imagery, or any other information. The information of the non-virtual environment may be received from any device (e.g., image/video capture device, sensor, or the like) and subsequently, in some embodiments, stored in the virtual content database 410. The virtual representation module 404 may also receive output from applications and/or programmers creating the virtual representation.

In step 504, the placement of the display is determined. The relative placement may determine possible viewpoints and the extent to which the virtual representation may be generated in step 506. In other embodiments, the placement of the display is not determined and more of the non-virtual environment may be generated as the virtual representation and reproduced as needed.

In step 508, the virtual representation module 404 may generate or create the virtual representation of the non-virtual environment based on the information received and/or stored in the virtual content database 410. In some embodiments, programmers and/or applications may generate the virtual representation. The virtual representation may be in two or three dimensions and display the virtual representation in a manner consistent with the non-virtual environment. The virtual representation may be stored in the virtual content database 410.

In step 510, the virtual content module 406 may generate virtual content. In various embodiments, programmers and/or application determine the function, depiction, and/or interaction of virtual content. The virtual content may then be generated and stored in the virtual content database 410.

In step 512, the display may be placed in the non-virtual environment. The display may be coupled to or may comprise the digital device 102. In some embodiments, the display comprises all or some of the modules and/or databases of the digital device 102.

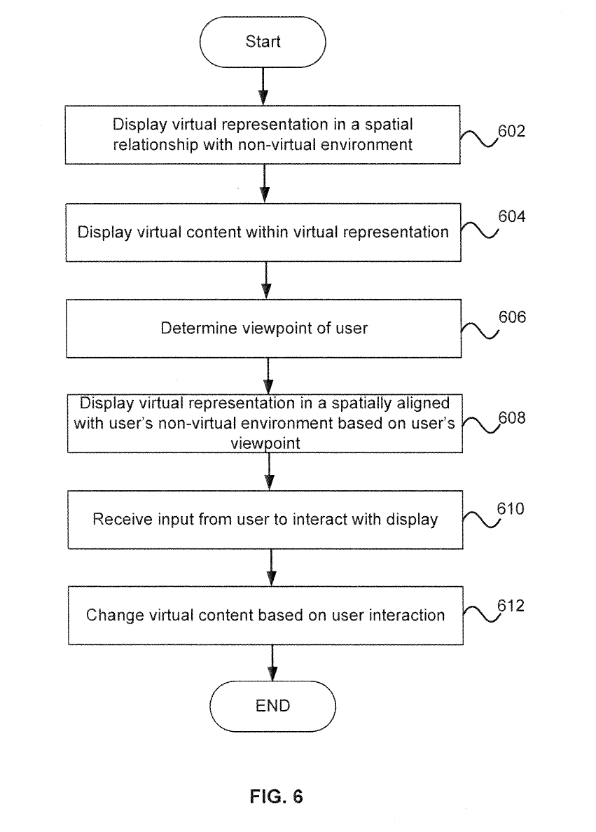

FIG. 6 is a flowchart of a method for displaying the virtual representation and virtual content in some embodiments. In step 602 the display displays the virtual representation in a spatial relationship with the non-virtual environment. In some embodiments, the display and/or digital device 102 determines the likely position of a user and generates the virtual representation based on the viewpoint of the user's likely position. The virtual representation may closely approximate the non-virtual environment (e.g., as a three-dimensional, realistic representation). In other embodiments, the virtual representation may appear to be two dimensional or a part of an illustration or animation. Those skilled in the art will appreciate that the virtual representation may appear in many different ways.

In step 604, the display may display virtual content within the virtual representation. For example, the virtual content may show text, images, objects, animals, or any depiction within the virtual representation as discussed herein.

In step 606, the viewpoint of a user may be determined. In one example, a user is detected. The proximity and viewpoint of the user may be also be determined by cameras, sensors, or other tracking technology. In some embodiments, an area in front of the display may be marked for the user to stand in order to limit the effect of proximity and the variance of viewpoints of the user.

In step 608, the virtual representation may be spatially aligned with the non-virtual environment based on an approximation or actual viewpoint of the user. In some embodiments, when the display re-aligns the virtual representation and/or virtual content, the display may gradually change the spatial alignment of the virtual representation and/or the virtual content to avoid jarring motions that may disrupt the experience for the user. As a result, the display of the virtual representation and/or the virtual content may slowly “flow” until the correct alignment is made.

In step 610, the virtual representation module 404 and/or the virtual content module 406 may receive an input from the user to interact with the display. The input may be in the form of an audio input, a gesture, a touch on the display, a multi-touch on the display, a button, joystick, mouse, keyboard, or any other input. In various embodiments, the virtual content module 406 may be configured to respond to the user's input as discussed herein.

In step 612, the virtual content module 406 changes the virtual content based on the user's interaction. For example, the virtual content module 406 may display menu options that allow for the user to execute additional functionality, provide information, or to manipulate the virtual content.

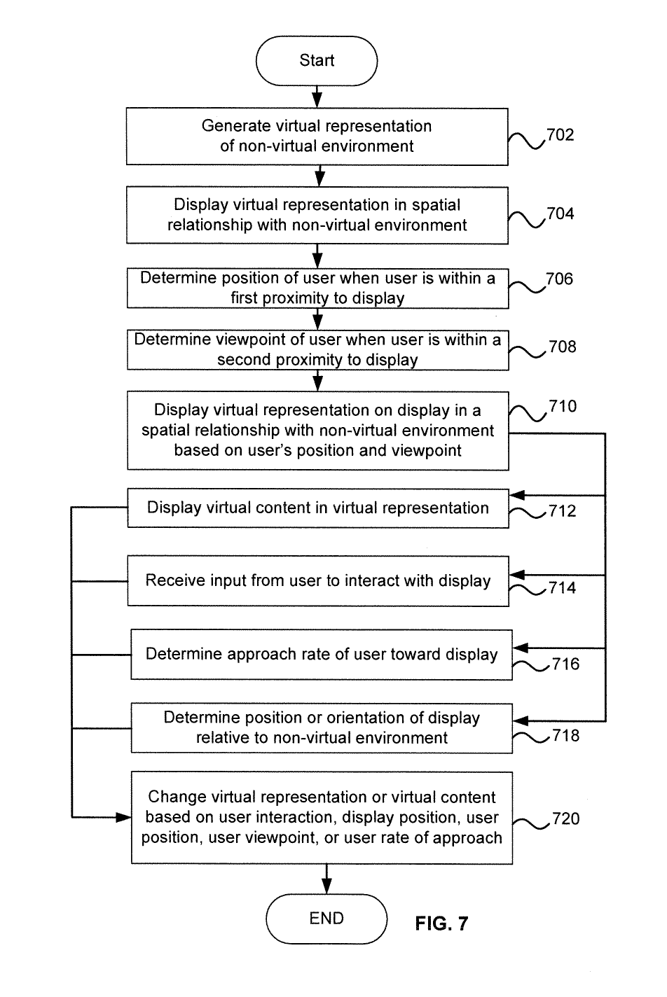

FIG. 7 is a flowchart of a method for using multiple sensors and user proximity to display the virtual representation and virtual content in some embodiments. The method begins at step 702, where the method may generate a virtual representation (e.g., the virtual duplicate of environment 308) of a non-virtual environment (e.g., actual environment 304). As described herein, the non-virtual environment is the actual environment in which a display may be placed. According to some embodiments, this may involve a virtual representation module 404 generating or creating the virtual representation of the non-virtual environment based on the information received and/or stored in a virtual content database 410, or a programmer and/or application generating the virtual representation. As described herein, the virtual representation may be in two or three dimensions and display the virtual representation in a manner consistent with the non-virtual environment. Once generated, the virtual representation may be stored in a virtual content database 410.

Next, in step 704, the display may show the virtual representation in a spatial relationship with the non-virtual environment. The virtual representation may be shown using, for example, the display interface module 402. The display may also show virtual content in the virtual representation. Assuming that a user's position or viewpoint have yet to be determined, in some embodiments, the display and/or digital device 102 determines the likely position of a user and generates the virtual representation based on the viewpoint of the user's likely position.

Subsequently, in step 706, the position of a user may be determined when the user is within a first proximity to the display. For example, in an embodiment using a sensor to detect the position of the user relative to the display, the user position module 412 may determine the user's position only when the user is within range of the sensor or only when the user is within a predefined distance from the display (e.g., ten feet). In some embodiments, the first proximity may be defined by a tracking zone monitored by the sensor, and the tracking zone is an area surrounding the display that is defined relative to the display. For instance, the first proximity may be defined by a tracking zone that forms a circular region around the display (e.g., zones 906, 908, and 910).

The tracking zones may be defined based on the sensor's range, the sensor's data quality or reliability for given ranges, and/or based on the availability of one or more other sensors to cover the same area (e.g., where another sensor is non-operational, the first sensor may take over monitoring its tracking zone). Also, as described herein, the tracking zone may be adjusted/redefined (with respect to its position relative to the display or dimensions) based on the time or date where the display is located, where the display is repositioned or reoriented, or based on a user's rate of approach toward the display. The sensor may comprise a variety of sensors, including cameras, position sensors, proximity sensors, and motion sensors.

In some embodiments, the display may show the virtual representation in a spatial relationship with the non-virtual environment based on the viewpoint of the user within the first proximity of the display.

In step 708, the viewpoint of the user may be determined when the user is within a second proximity to the display. For example, where an embodiments using the sensor to detect the viewpoint of the user relative to the display, the viewpoint module 408 may determine the user's viewpoint when the user is within range of the sensor and/or when the user is within a specified distance from the display (e.g., 5 ft). In some embodiments, the second proximity may be defined by a tracking zone monitored by the sensor, and the tracking zone is an area surrounding the display that is defined relative to the display. For instance, the first proximity may be defined by a tracking zone that forms a circular region around the display (e.g., zones 906, 908, and 910). As described herein, the tracking zone may be defined based on the sensor's range, the sensor's data quality or reliability for given ranges, or on the availability of other sensors to cover the same area.

It should be noted that depending on the embodiment, the first proximity may be greater than, less than, or equal to the second proximity. Additionally, in varying embodiments, the one or more tracking zones may be mutually exclusive, partially overlapping, or completely overlapping with each other.

In step 710, the display may show the virtual representation such that the virtual representation is in a spatial relationship with the non-virtual environment in which the display is placed. The spatial relationship may be based on the user's position and the user's viewpoint, as determined in steps 706 and 708. Where the virtual representation is being shown on the display (e.g., due to step 704), step 710 may re-align the virtual representation (and any virtual content being shown on the virtual content) such that the virtual representation (and its virtual content) is in a spatial relationship with the non-virtual environment in which the display is placed. In some embodiments, the display may shift or alter the depiction of the virtual representation gradually to avoid jarring motions that may disrupt the experience for the user. As a result, the display of the virtual representation and/or the virtual content may slowly “flow” until the correct alignment is made.

Following the display of virtual representation, the method may perform a number of additional steps. In step 712, the virtual content may be shown in the virtual representation. For instance, the virtual content may show text, images, objects, animals, or any depiction within the virtual representation as discussed herein.

In step 714, the virtual representation module 404 or the virtual content module 406 may receive an input from the user to interact with the display. In response, the virtual representation module or the virtual content module may adjust the virtual representation and the virtual content. As described herein, the input may be in the form of an audio input, a gesture (e.g., tracking of hand, arm, or leg position to determine motion), a touch on the display, a multi-touch on the display, a button, joystick, mouse, keyboard, or any other input. In various embodiments, the virtual content module 406 may be configured to respond to the user's input as discussed herein.

In step 716, the user's rate of approach toward the display may be determined. For instance, in some embodiments, the user position module 412 may be utilized to track a user's position over time in order to determine at which direction the user is approaching the display and at what rate. As described herein, the user's rate of approach can subsequently be used to determine the rate of adjustment and refresh for the virtual representation being shown on the display, or used to determine what virtual content should be shown in the virtual representation.

In step 718, the position or orientation of the display with respect to the non-virtual environment may be determined. For example, the display position module 414 may be used to determine the display's position relative to the non-virtual environment, and the display orientation module 416 may be used to determine the display's orientation relative to the non-virtual environment. As described herein, such display position or orientation information can be used to adjust the spatial relationship between the virtual representation, virtual content, and non-virtual environment. For example, if the display is repositioned within the non-virtual environment, or the display is reoriented such that the back of the display pointed else where in the non-virtual environment, such changes could be detected and spatially realign can be performed so that a user continues to perceive a virtual duplicate of the non-virtual environment behind the display on the display.

In step 720, the user interaction, display position, user position, user viewpoint, user rate of approach, or some combination thereof, may cause the display to change the virtual representation or virtual content it is currently displaying. The virtual representation module 404 may facilitate changes to the virtual representation and the virtual content module 406 may facilitate changes to the virtual content. Based on user interaction, display position, user position, user viewpoint, or user rate of approach, the display may, for example, change what virtual content is shown in the virtual representation (e.g., change the text or image shown as virtual content), or adjust the spatial relationship of the virtual representation or the virtual content with respect to the non-virtual environment. For instance, the display may align or realign the virtual representation with the non-virtual environment based on the viewpoint or the proximity relative to the display. For example, a user standing a distance of ten feet or more from the display may perceive less detail of the non-virtual environment and, as such, a virtual object in the virtual representation may be depicted as smaller, in different light, and/or in more detail (e.g., increased detail of the feathers of the bird) than if the user was standing closer (e.g., 2 feet) from the display.

Those skilled in the art will appreciate that there may be any number of sensors configured to detect one or more users in any number of tracking zones relative to the display. Further, each sensor may comprise multiple sensors. Each sensor may use any kind of technology to detect the user and determine distance, including, but not limited to, radio waves, acoustic waves, radar, and/or camera. In some embodiments, cameras may allow the virtual representation to interact with the user (e.g., display virtual content as being worn by the user) and/or determine the user's position relative to the display and/or the tracking zones.

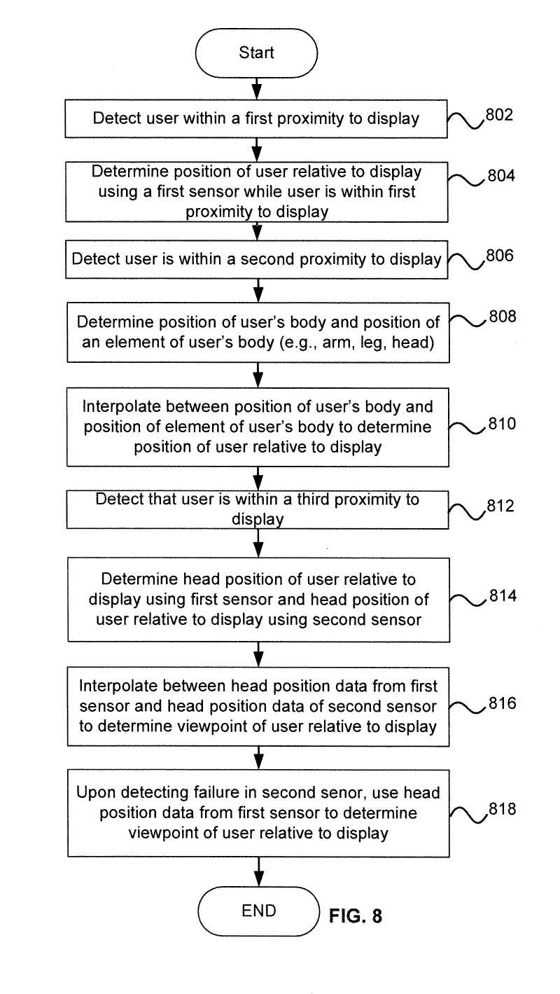

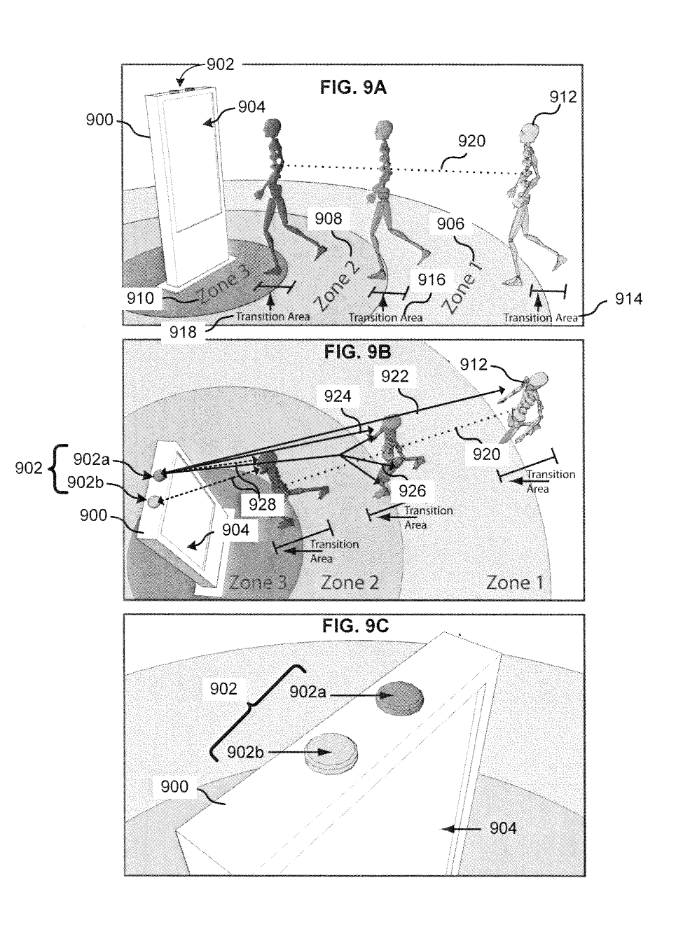

FIG. 8 is a flowchart of a method for using multiple sensors and user proximity to display the virtual representation and virtual content in some embodiments. The flowchart of FIG. 8 illustrates a method of using different blends of sensors to various monitor areas around a display based on user proximity to the display. To better describe FIG. 8, we first turn to FIGS. 9A-C, which illustrate an exemplary non-transparent display in accordance with an embodiment.

FIGS. 9A-C are diagrams of an exemplary non-transparent display in some embodiments. FIGS. 9A-C illustrate different views for the same exemplary non-transparent display. In FIGS. 9A-C, a display 900 is shown in accordance with an embodiment. As shown, the display comprises a screen 904 and sensors 902, the sensors comprising a first sensor 902a and a second sensor 902b. Also shown is a user 912 approaching the display along an approach path 920.

The sensors 902 may be configured to monitor areas surrounding the display 900 (i.e., zones or tracking zones) and track users as they enter and remain in those areas. For example, sensors 902 may detect when the user 912 is in zone one 906, when the user 912 is zone two 908, and when the user 912 is zone three 910. Additionally, the sensors 902 may detect transitions, when the user 912 initially enters zone one 906 at transition 914, when the user 912 transitions from zone one 906 to zone two 908 at transition 916, and when the user 912 transitions from zone two 908 to zone three 910 at transition 918. For some embodiments, the transitions areas 914, 916, and 918 may be utilized to determine the user 912 rate of approach or to determine when tracking of the user 912 should be taken over or augmented by another sensor (e.g., as the user 912 transitions from zone two to zone three at transition 918, both sensors 902a and 902b may begin tracking the user 912). As described herein, depending on the sensors 902 used, tracking of the user 912 may involve face tracking, position tracking, motion tracking, or the like.

In some embodiments, each (tracking) zone may be monitored by a different set of sensors from the sensors 902. For example, as illustrated in FIG. 9B, the sensor 902a may be configured to track 922 the position of the user 912 relative to the display 900 when the user 912 is in zone one 906, to track 924 the position of the user 912 when the user 912 is in zone two 908, and to track 926 the position of the user's arms and legs when the user 912 is in zone two 908. As also illustrated, when the user 912 is within zone three 918, the sensor 902a and the sensor 902b may be configured to track 928 the user's head position. As described herein, the sensors 902 may engage and begin tracking aspects of the user 912 (e.g., general position, head position, or viewpoint) based on which transition areas (i.e., transition areas 914, 916, and 918) the user 912 enters and when the user 912 crosses those transitions areas.

The sensors 802 may comprise a variety of sensors, including cameras, position sensors, proximity sensors, motion sensors, light sensors, radar, and laser range detectors. For example, the sensor 902a may comprise laser range detector capable of detecting the position of the user 912 or the position of the user's arms, legs, or head relative to the display, while the sensor 902b may comprise a face tracking camera capable of tracking the viewpoint of the user 912 relative to the screen 904 and detecting the position of the user 912 relative to the display 900.

It should be noted that although FIGS. 9A-C depict a display comprising two sensors and three tracking zones, those skilled in the art will appreciate that some embodiments may comprise more or less sensors and more or less tracking zones than shown.

Turning now to FIG. 8, the method begins at step 802, where a user 912 may be detected within a first proximity to the display 900, such that the user 912 is detected within zone one 906. As noted herein, the first proximity may be defined by a tracking zone 914 monitored by one or more sensors 902a, and the detection of the user 912 entering the zone 906 may be facilitated by the sensor(s). For example, as the user 912 crosses through transition area 914 into zone one 906, the first sensor 902a detects the user 912 within the first proximity and engages itself in order to provide the approximate position of the user 912. Those skilled in the art will appreciate that a proximity zone may be characterized as a tracking zone.

In various embodiments, the virtual representation of the display 900 may change to the viewpoint of the user 912. In some embodiments, if the viewpoint of the user 912 may be approximated if the user 912 is too far from the display but within a zone, the virtual representation may be based on a general viewpoint. For example, the viewpoint may be based on a position in the middle of zone one 906 in the general direction of the detected user 912.

In step 804, the display 900 may determine the position of the user 912 relative to the display using the first sensor 902a while the user 912 is within the first proximity zone. For instance, if the first proximity zone is set at fifteen feet, when the user 912 is within fifteen feet of the display 900, the first sensor 902a may detect 922 the position of the user 912 with respect to the display 900. In various embodiments, the virtual representation of the display 900 may change to the viewpoint at the position of the user 912.

In step 806, the user 912 may be detected within a second proximity zone to the display 900, such that the user 912 is detected within zone two 908. As noted herein, the second proximity zone may be defined by a tracking zone 916 monitored by one or more given sensors 902a, and the detection of the user 912 entering the zone may be facilitated by the given sensors. For example, as the user 912 crosses into zone two 908 over transition area 916, the first sensor 902a detects the user 912 within the second proximity and remains active in order to provide the further position information regarding the user 912.

Subsequently, in step 808, while the user 912 is within the second proximity, the display 900 may determine the position of the user's body relative to the display using the first sensor 902a, and determine the position of elements of the user's body (e.g., arms, legs, etc.) relative to the display using the first sensor 902a. For instance, if the second proximity zone is set at ten feet, when the user 912 is within ten feet of the display 900, the first sensor 902a may detect 924 the position of the user's body with respect to the display 900 and detect 926 the position of the user's limbs with respect to the display 900.

In various embodiments, the display 900 may continue to update the virtual representation at the user's changing viewpoint. Further, the display 900 may allow the user 912 to interact with the virtual representation or content within the display 900 (e.g., a depiction of a person may move their hands in a manner similar to movement of the user 912).

Although FIGS. 9A-C depict multiple sensors (i.e., sensors 902a and 902b), those skilled in the art will appreciate that there may be any number of sensors. For example, a single sensor may be used to determine the distance of the user 912, the position of the user 912 relative to tracking zones, positions of extremities (e.g., arms or legs) and head, and/or rate of approach.

At step 810, the display may interpolate between the data regarding the position of the user's body relative to the display 900 and the data regarding the position of elements of the user's body (e.g., arms, legs, etc.) relative to the display 900 using the first sensor 902a. The resulting interpolated data may provide the display 900 with more accurate and reliable position information regarding the user 912.

In step 812, the user 912 may be detected within a third proximity zone to the display 900, such that the user 912 is detected within zone three 910. As noted herein, the third proximity zone may be defined by a tracking zone 910 as the user 912 passes transition area 918 monitored by one or more given sensor 902a and 902b, and the detection of the user 912 entering the zone may be facilitated by the given sensors. For example, as the user 912 crosses into zone three 910, the first sensor 902a and the second sensor 902b may detect the user 912 within the third proximity, the first sensor 902a may remain active in order to provide the further position information regarding the user 912, and the second sensor 902b may engage itself to provide viewpoint information.

After, in step 816, while the user 912 is within the third proximity, the display 900 may determine the head position of the user's body relative to the display using the first sensor 902a, and determine the head position of the user's body relative to the display using the second sensor 902b. For instance, if the third proximity is set at five feet, when the user 912 is within five feet of the display 900, each of the first sensor 902a and the second sensor 902b may detect 928 the head position of the user's body with respect to the display 900.

At step 818, the display may interpolate between the data from the first sensor 902a regarding the head position of the user's body relative to the display 900, and the data from the second sensor 902b regarding the head position of the user's body relative to the display 900. The resulting interpolated data may provide the display 900 with more accurate and reliable position information regarding the user's head and/or viewpoint.

In step 820, when a failure is detected in the second sensor (e.g., signal lost with the second sensor, invalid data being provided by the second sensor), the display may reconfigure itself to use the head position data from the first sensor in determining the user's head position. For example, where the second sensor 902b provides more accurate position data regarding a user's head than the first sensor 902a, when the second sensor stop providing head position data to the display, the display may reconfigure itself to rely on the less accurate data from the first sensor 902a when determining the user's head position.

It should be noted and understood that for some embodiments, the level of detailed data a sensor can detect and obtain regarding a user 912 may be dependent on the distance between the sensor and the user 912. For example, a position sensor in an embodiment may only detect an approximate position of a user 912 when they user 912 is fifteen feet away from the display, but may detect position information regarding a user's arms, legs, and head, when the user 912 is seven feet away from the display.

In various embodiments, one or more of the tracking zones dynamically change over time. For example, the display 900 and/or the sensors may be configured to alter the size and/or shape of one or more tracking zones, add more tracking zones, and/or decrease the number of tracking zones based on any number of factors. For example, the display 900 may be configured to shrink the number and/or size of tracking zones when expected foot traffic is to increase. In one example, the display 900 is at a mall and the display 900 is configured to shrink the size of tracking zones at 5:00 PM as crowds increase. Similarly, when the crowds decrease, the display 900 may be configured to increase the size of the tracking zones. In some embodiments, the display 900 and/or the sensors 902 are preconfigured. In various embodiments, the sensors may detect crowds and/or increased foot traffic; as a result, the sensors may dynamically decrease the size of the zones or decrease the number of zones if the size of the crowd increases and/or places strain on the system. Those skilled in the art will appreciate that the display 900 and/or the sensors 902 may be configured to dynamically increase or decrease the zones based on foot traffic volume, foot traffic proximity to the display 900, time of day, and the type of media campaign (e.g., advertisement of new Iron Man® movie which may preferably interact with one user at a time).

Various embodiments discussed herein may also include priority zones. Priority zones may be defined around the display 912 to help prioritize interactions with one or more people. In some embodiments, the priority zones are equal in number, size, and shape to the tracking zones. In various embodiments, there may be any number of priority zones regardless of the number of tracking zones. Similarly, priority zone may be any size or shape regardless of the size and shape of the tracking zones.

In one example, a first priority zone may be defined as within the first tracking zone 906 and close to the transition area 914. A group of users passing through the first tracking zone 906 but not through the transition area 914 may view a virtual representation within the display at a general viewpoint set approximately at the middle of the first tracking zone. If a user crosses the proximity zone, the display 900 may give that user the highest priority (e.g., by altering or shifting the viewpoint to the user's position and rate of approach). Further, a user that passes through a proximity zone may interact with the virtual representation and/or virtual contact of the display 912.

Those skilled in the art will appreciate that multiple users may be given different priority based on the users positions relative to one or more priority zones. As a result, the virtual representation and/or virtual content may be viewable and remain interactive with any number of users based on the positions relatives to the one or more priority zones. In one example, a subset of the users of a group of users may interact with the virtual representation (e.g., the subset appears in the virtual representation to be a group of cowboys in a western theme). Further, the display 912 and/or sensor 902 may average the position of the viewpoint based on the average positions of the subset of users for generating the virtual representation and/or virtual content.

The users' different proximity to different priority zones may also affect prioritization. Those closer to the display may be within the closest priority zone and, as a result, the display 912 may alter the virtual representation and/or virtual content based on those with the highest priority (e.g., those within the closest priority zone) over those that are further away.

In various embodiments, there may be one or more defined hotspots relative to the display 912. A hotspot is a position or zone relative to the display 912 that may trigger changes to the virtual representation and/or virtual content. For example, when a user enters or passes a hotspot, the display 912 may display information and/or an advertisement (e.g., the display 912 displays an advertisement in a representation of the user's surroundings). One or more hotspots may be positioned relative to or in the same position as the priority zones and/or the proximity zones. The size and shape of any number of hotspots may be similar to the size and shape of a priority zone and/or a proximity zone. Alternately, one or more hotspots may be independent of the position, size, or shape of priority zones and/or proximity zones.

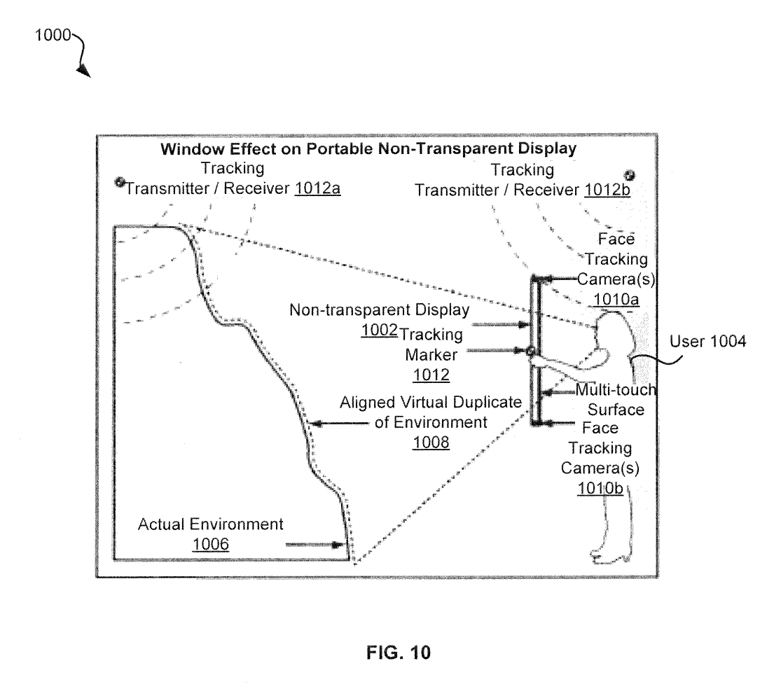

FIG. 10 depicts a window effect on a non-transparent display 1000 in some embodiments. In some embodiments, the display may be mobile, hand-held, portable, moveable, rotating, and/or head-mounted. In the case of non-dynamic, fixed location displays, the 3D position and 3D orientation of the display with respect to a physical and corresponding virtual registration point may be manually calibrated upon initial set-up of the display. In the case of dynamic, moving displays, the 3D position and 3D orientation may be captured utilizing a tracking technology. The position and orientation of the facial tracking cameras may be extrapolated once the values for the display have been established.

FIG. 10 comprises a non-transparent display 1002 between an actual environment 1006 (i.e., the user's non-virtual environment) and the user 1004. The user 1004 may view the display 1002 and perceive an aligned virtual duplicate of the actual environment 1008 (i.e., a virtual representation of the user's non-virtual environment) behind the display 1002. The virtual duplicate of the actual environment 1008 is aligned with the actual environment 1006 such that the user 1004 may perceive the display 1002 as being partially or completely transparent.

In some embodiments, the position and/or orientation of the portable display 1002 may be determined by hardware within the display 1002 (e.g., GPS, compass, accelerometer and/or gyroscope) and/or transmitters. In one example, tracking transmitter/receivers 1012a and 1012b may be positioned in the actual environment 1006. The tracking transmitter/receivers 1012a and 1012b may determine the position and orientation of the display 1002 using the tracking marker 1012. Those skilled in the art will appreciate that the orientation and/or position of the display 1002 may be determined with or without the tracking marker 1012. With the information, the display 1002 may make corrections to the alignment of the virtual duplicate of the environment 1008 so that a spatial relationship is maintained. Similarly, changes to virtual content may be made for consistency. In some embodiments, the display 1002 determines the viewpoint of the user based on signals received from the tracking transmitter/receivers 1012a and 1012b and/or face tracking camera(s) 1010a and 1010b.

FIG. 11 depicts a window effect on layered non-transparent displays 1100 in some embodiments. Any number of displays may interact together to bring a new experience to the user 1102. FIG. 11 depicts two displays including a non-transparent foreground display 1104a and a non-transparent background display 1104b. The user 1102 may be positioned in front of the foreground display 1104a. The foreground display 1104a may display a virtual representation that depicts both the non-virtual environment between the two displays as well as the virtual representation and/or virtual content of the background display 1104a. The background display 1104a may display only virtual content, display a virtual representation of the non-virtual environment behind the background display 1104a, or a combination of the virtual representation and the virtual content.

In some embodiments, a part of the non-virtual environment may be between the two displays as well as behind the background display 1104a. For example, if an automobile is between the two displays, the user may perceive a virtual representation of the automobile in the foreground display 1110 but not in the background display 1104b. For example, if the user 1102 was to look around the foreground display 1110, they may perceive the automobile in the non-virtual environment in front of the background display 1104b but not in the virtual representation of the background display 1104b. In some embodiments, the background display 1104b displays a scene or location. For example, if an automobile is between the two displays, the foreground display 1104a may display a virtual representation and virtual content to depict the automobile as driving while the background display 1104a may depict a background scene, such as a racetrack, coastline, mountains, or meadows.

In some embodiments, the background display 1104b is larger than the foreground display 1104a. The content of the background display 1104b may be spatially aligned with the content of the foreground display 1104a so that the user may perceive the larger background display 1104b around and/or above the smaller foreground display 1104a for a more immersive experience.

In some embodiments, virtual content may be depicted on one display but not the other. For example, in-between content 1110, such as a bird, may be depicted in the foreground display 1104a but may not appear on the background display 1104b. In some embodiments, virtual content may be depicted on both displays. For example, aligned virtual content 1108, such as a lamp on a table, may be displayed on both the background display 1104b and the foreground display 1104a. As a result, the user may perceive the aligned virtual content 1108 behind both displays.

In various embodiments, the viewpoint 1106 of the user 1102 is determined. The determined viewpoint 1106 may be used by both displays to alter spatial alignment to be consistent with each other and the user's viewpoint 1106. Since the user's viewpoint 1106 is different for both displays, the effect of the viewpoint may be determined on the virtual representation and/or the virtual content on both displays.

Those skilled in the art will appreciate that both displays may share one or more digital devices 400 (e.g., one or more digital devices 202 may generate, control, and/or coordinate the virtual representation and/or the virtual content on both displays). In some embodiments, one or both displays may be in communication with one or more separate digital devices 400.

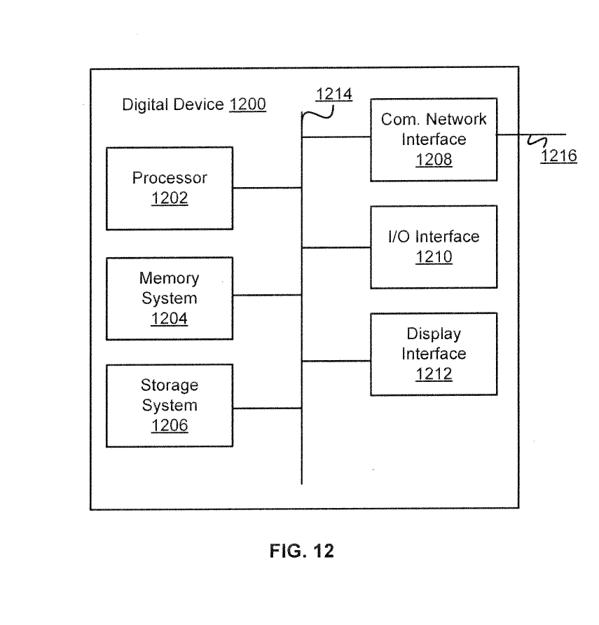

FIG. 12 is a block diagram of an exemplary digital device 1200. The digital device 1200 comprises a processor 1202, a memory system 1204, a storage system 1206, a communication network interface 1208, an I/O interface 1210, and a display interface 1212 communicatively coupled to a bus 1214. The processor 1202 is configured to execute executable instructions (e.g., programs). In some embodiments, the processor 1202 comprises circuitry or any processor capable of processing the executable instructions.

The memory system 1204 is any memory configured to store data. Some examples of the memory system 1204 are storage devices, such as RAM or ROM. The memory system 1204 can comprise the ram cache. In various embodiments, data is stored within the memory system 1204. The data within the memory system 1204 may be cleared or ultimately transferred to the storage system 1206.

The storage system 1206 is any storage configured to retrieve and store data. Some examples of the storage system 1206 are flash drives, hard drives, optical drives, and/or magnetic tape. In some embodiments, the digital device 1200 includes a memory system 1204 in the form of RAM and a storage system 1206 in the form of flash data. Both the memory system 1204 and the storage system 1206 comprise computer readable media which may store instructions or programs that are executable by a computer processor including the processor 1202.

The communication network interface (com. network interface) 1208 can be coupled to a network (e.g., communication network 114) via the link 1216. The communication network interface 1208 may support communication over an Ethernet connection, a serial connection, a parallel connection, or an ATA connection, for example. The communication network interface 1208 may also support wireless communication (e.g., 802.11a/b/g/n, WiMax). It will be apparent to those skilled in the art that the communication network interface 1208 can support many wired and wireless standards.

The optional input/output (I/O) interface 1210 is any device that receives input from the user and output data. The optional display interface 1212 is any device that is configured to output graphics and data to a display. In one example, the display interface 1212 is a graphics adapter.

It will be appreciated by those skilled in the art that the hardware elements of the digital device 1200 are not limited to those depicted in FIG. 12. A digital device 1200 may comprise more or less hardware elements than those depicted. Further, hardware elements may share functionality and still be within various embodiments described herein. In one example, encoding and/or decoding may be performed by the processor 1202 and/or a co-processor located on a GPU (i.e., Nvidia®).

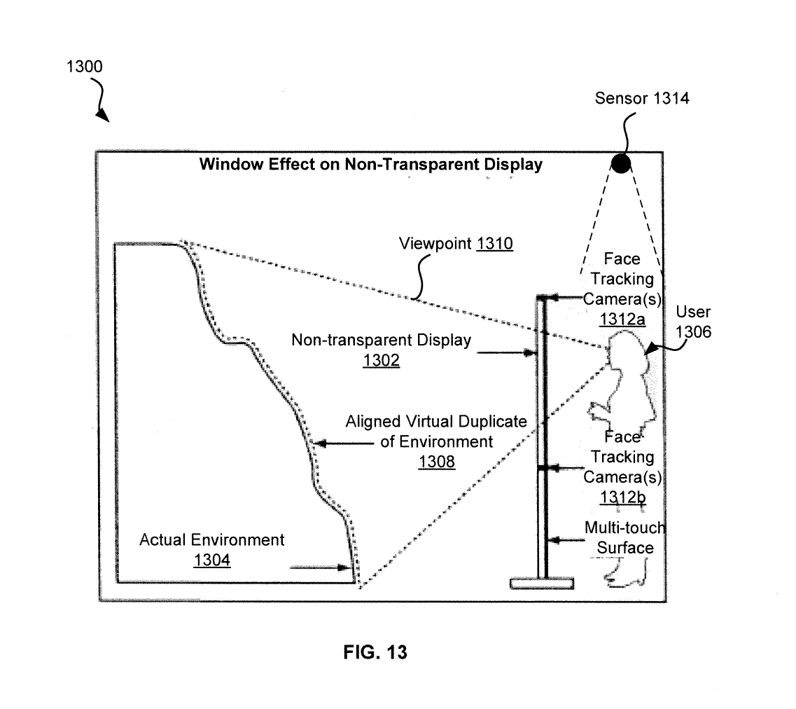

FIG. 13 depicts a window effect on a non-transparent display 1300 in some embodiments. In some embodiments, the display 1300 may be mobile, hand-held, portable, moveable, rotating, and/or head-mounted. The position and orientation of the facial tracking cameras may be extrapolated once the values for the display have been established.

FIG. 13 comprises a non-transparent display 1302 between an actual environment 1306 (i.e., the user's non-virtual environment) and the user 1304. The user 1304 may view the display 1302 and perceive an aligned virtual duplicate of the actual environment 1308 (i.e., a virtual representation of the user's non-virtual environment) behind the display 1302. The virtual duplicate of the actual environment 1308 is aligned with the actual environment 1306 such that the user 1304 may perceive the display 1302 as being partially or completely transparent. FIG. 13 also comprises an overhead sensor 1314.

In various embodiments, the overhead sensor 1314 identifies the head of the user 1306 and/or the head region of interest based on the position of the user's head. In one example, the overhead sensor 1304 assists in determining the head region of interest from the top of the user's head to a point that is downwards a distance that is similar to ½ the average length of a user's head. The overhead sensor 1314 may also define an arms region of interest as a region beginning with the bottom of the head region of interest to a distance that is the average length of a user's arms.

In some embodiments, one or more face tracking camera 1312a-b may perform face and/or arm tracking utilizing the head region of interest and the arms region of interest. In some embodiments, the overhead sensor 1314 determines a position of the user 1306 to the non-transpiration display 1302. As a result, in some embodiments, the face tracking cameras 1312a-b may not determine the position of the user or define a head region of interest or an arms region of interest. The face tracking cameras 1312a-b may focus on dynamically determining the position (e.g., three-dimensional coordinates relative to the display 1302) of the user's head and determining movement in those areas of interest and providing the information to the non-transparent display 1302 such that the virtual duplicate of the environment 1308 may react.

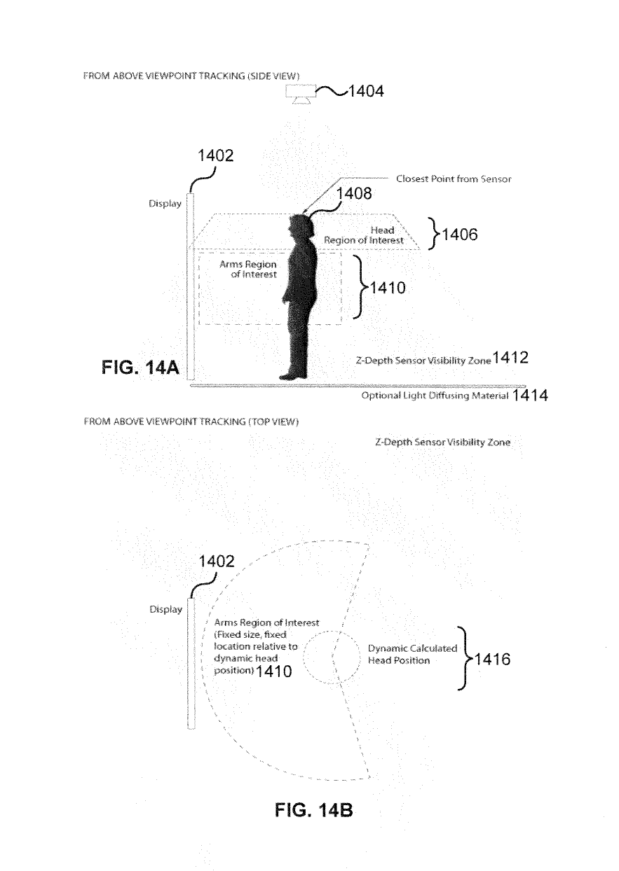

FIGS. 14A and 14B depict a head region of interest 1406 and an arms region of interest 1410 of a user 1408 in some embodiments. FIG. 14A depicts a display 1402, an overhead sensor 1404 configured to scan a z-depth sensor visibility zone 1412. The overhead sensor 1404 may assist in determining a head region of interest 1406 of the user 1408 and an arms region of interest 1410.

In various embodiments, the overhead sensor 1404 is positioned above and in front of the display 1402 such that the overhead sensor 1404 may be above a user 1408. The overhead sensor 1404 may scan the z-depth sensor visibility zone 1412. In some embodiments, there may be multiple sensors. For example, one sensor (e.g., a sensor coupled to the display 1402) may detect movement in front of the display 1402. The overhead sensor 1404 may be activated and/or beginning scanning the z-depth sensor visibility zone 1412 for a user. Information from the overhead sensor 1404 may be provided to the display 1402 and/or a digital device couple to the display 1402).

The overhead sensor 1404 may detect the user 1408. In some embodiments, the overhead sensor 1404 and/or the depth sensor module may determine the position of the user, movement of the user, rate of approach, and the like.

The overhead sensor 1404 may also assist in determining the head region of interest 1406. For example, the overhead sensor 1404 may determine the closest point from the sensor. The closest point from the sensor may be assumed to be the top of the head of the user. In some embodiments, the overhead sensor 1404 and/or the head position module attempts to verify that the object with a point that is closest to the sensor is the user's head. For example, the overhead sensor 1404 and/or the head position module may determine the height of the closest point from the sensor over the ground. If the height is insufficient to be the head of the user, the overhead sensor 1404 may continue scanning the area to identify another object. In some embodiments, the overhead sensor 1404 and/or the head position module applies information from one or more other sensors to confirm the general position of the user's head (e.g., blob recognition, face recognition or shape recognition).

There are many different ways an object's proximity to the overhead sensor 1404 may be determined and/or measured. In various embodiments, the depth module 418 may extrapolate information from the overhead sensor 1404 to determine distance or an absolute distance an object is from the sensor 1404 (i.e., a z-depth). In some nonlimiting examples, the depth module 418 extrapolates the information from the overhead sensor 1404 using time of flight, stereo camera pairs, or structured light. Those skilled in the art will appreciate that the overhead sensor 1404 may acquire sufficient frame rates to support dynamic depth values.

If a head of a user has been identified, the overhead sensor and/or the head position module may define the head region of interest 1406 as extending from the point closest to the sensor downward a distance equivalent to the average length of a user's head. In some embodiments, the overhead sensor 1404, the head position module, and/or one or more other sensors may detect a user's head and then detect the user's shoulders and/or chest. The head region of interest 1406 may be defined as the space between the point closest to the sensor 1408 and the position of the user's shoulders and/or chest. Those skilled in the art will appreciate that the head region of interest 1406 may be determined in any number of ways.

Further, the overhead sensor 1404 may also assist in determining the arms region of interest 1406. For example, the overhead sensor 1404 and/or the body position module may determine the arms region of interest from the bottom of the head region of interest 1406 extending downward a distance equivalent to the average length or a portion of an average length of the user's arms. In some embodiments, other sensors (e.g., coupled to the display 1402) may assist in determining the length of the arms of the user or the position of the arms of the user.

FIG. 14B depict the arms region of interest from above the user as well as a dynamic calculated head position 1416 in some embodiments. In various embodiments, once the arms region of interest 1410 is defined, the overhead sensor 1404 and/or one or more other sensors may scan the arms region of interest to determine the position, orientation, rate of motion, and direction of a user's arms and/or hands (e.g., via blob recognition and then further scanning to identify a position, such as a three dimensional position, of a user's arms and/or hands relative to the display). As a result of segmenting the space in front of the display 1402, sensors may be focused on the regions of interest rather than scanning all of the area in front of the display 1402 for arm motion. The arms region of interest 1410 may be fixed in size and be a fixed location relative to a dynamic head position 1416.

In various embodiments, the user may be determined to be a child or adult. Further, the adult may be determined to be tall or short. Height and age may effect the determination of the size of the arms region of interest.

The head position 1416 may be dynamically calculated. For example, one the head region of interest 1406 is defined, that space may be scanned (e.g., by sensors within the display 1402 and/or the overhead camera 1404) to detect an object in the area. The object may be recognized as the user's head (e.g., via face, shape, or blob recognition) and then further assessed to determine position, viewpoint, and, in some embodiments, expression. The position of the head of a user and/or the head region of interest may be updated to track the user's head, viewpoint, expression, and the like. The position of the head of the user may be used to determine the head region of interest and, from there, the arms region of interest. In some embodiments, if the head position changes, the head and arms regions of interest may be re-determined and/or re-calculated.

In some embodiments, the floor in front of the display 1402 may comprise an optional light diffusing material 1414 to enhance the resolution, scanning, position of the user 1408, position of the head region of interest 1406, and/or the positions of the arms region of interest 1410. The optional light diffusing material 1414 may be of any color or material configured to diffuse light in the area of the user and/or the area in front of the display 1402. In some embodiments, the light diffusing material 1414 may span all or part of the z-depth sensor visibility zone 1412.

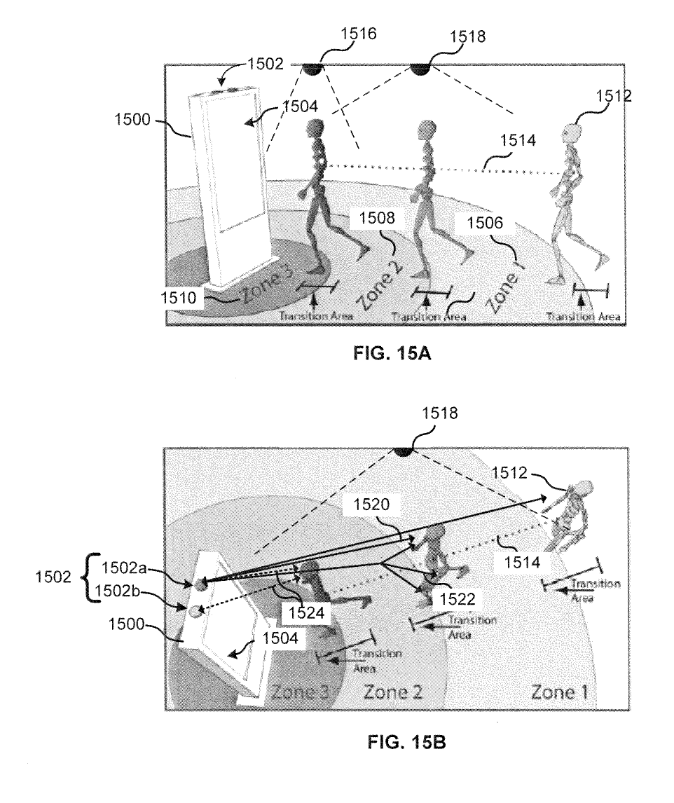

FIGS. 15A and 15B depict an area in front of a display 1500 comprising three sensors 1502, 1516, and 1518 and three tracking zones 1506, 1508, and 1510 in some embodiments. Those skilled in the art will appreciate that some embodiments may comprise more or less sensors and more or less tracking zones than shown. In FIG. 15a, the system comprises a display 1500, first and second sensors 1502, a virtual representation 1504, proximity zone one 1506, proximity zone two 1508, proximity zone three 1510, a user 1512, a user's path 1514, and two overhead sensors 1516 and 1518.

The overhead sensors 1516 and 1518 may be coupled within a ceiling, lighting fixture, or any overhead structure. In some examples, the overhead sensors 1516 and 1518 may be embedded within or dangle from any overhead structure. An overhead structure is any structure that allows one or more sensors to be above a region in front of the display 1500.

In various embodiments, the overhead sensor 1518 and/or a depth module associated with the display 1500 detects the presence of a user in proximity zone one 1506. The overhead sensor 1518 and/or the depth module may identify the position and rate of motion of the user. In some embodiments, the overhead sensor 1518 and/or the depth module provide the position information to the display 1500 which may depict a virtual representation 1504 based on a viewpoint of the user 1512 within the proximity zone one 1506. In some embodiments, the overhead sensor 1518 and/or the depth module may determine a head region of interest of the user 1512 and the virtual representation 1504 depicted by the display 1500 may be based on a viewpoint of the user 1512 from the head region of interest. As the sensor 1518 and/or the depth module tracks the user 1512 along path 1514, the virtual representation of the viewpoint of the user may also change.

The overhead sensors 1518 and/or 1516 may also detect the user 1512 as the user transitions into proximity zone 1508. The overhead sensors 1516 and/or 1518 may also assist in determining the position and relative rate of approach of the user 1516. In various embodiments, the overhead sensor 1516 and/or the head position module may determine the head region of interest such that the position of the user's head may be determined and the virtual representation may be altered based on the position of the user's head, the user's viewpoint, and/or the user's motion. Further, the overhead sensor 1516 and/or the body position module may determine the arms region of interest such that the virtual representation may be altered based on the position of the user's arms, the user's arm movement, and/or the user's motion.

Those skilled in the art will appreciate that, in some embodiments, the overhead sensor 1518 may detect a position of a user and the overhead sensor 1516 may assist in the determination of the different zones of interest. Further, the operations of the overhead sensors 1516 and/or 1518 may also take into account input from the sensors 1502.

In FIG. 15b, the system comprises a display 1500, first and second sensors 1502a-b, a virtual representation 1504, overhead sensor 1518 zone one viewpoint 1520, zone two viewpoint 1522, and zone three viewpoint 1524.

In various embodiments, the overhead sensor 1518 and/or a depth module associated with the display 1500 detects the presence of a user in proximity zone one, two, or three. The overhead sensor 1518 and/or the head position module may determine the head region of interest for the user 1512 in any zone. Further, the overhead sensor 1518 and/or the body position module may determine the arms region of interest for the user 1512 in any zone. In various embodiments, the overhead sensor 1518 provides information related to scanning to the digital device 1500. The information from the overhead sensor 1518 may be combined or be in addition to information from the sensors 1502 A and/or B. The information from the sensors and/or the head position of interest may be used to determine a position of the user's head and/or a viewpoint 1524 of a user in the third zone, a viewpoint 1522 of a user in the second zone, and/or a viewpoint 1512 of a user in the first zone. The virtual representation may be altered and/or adjusted such that the virtual representation appears from the viewpoint of the user in one or more of the zones thereby, in some embodiments, adding to the immersive experience.

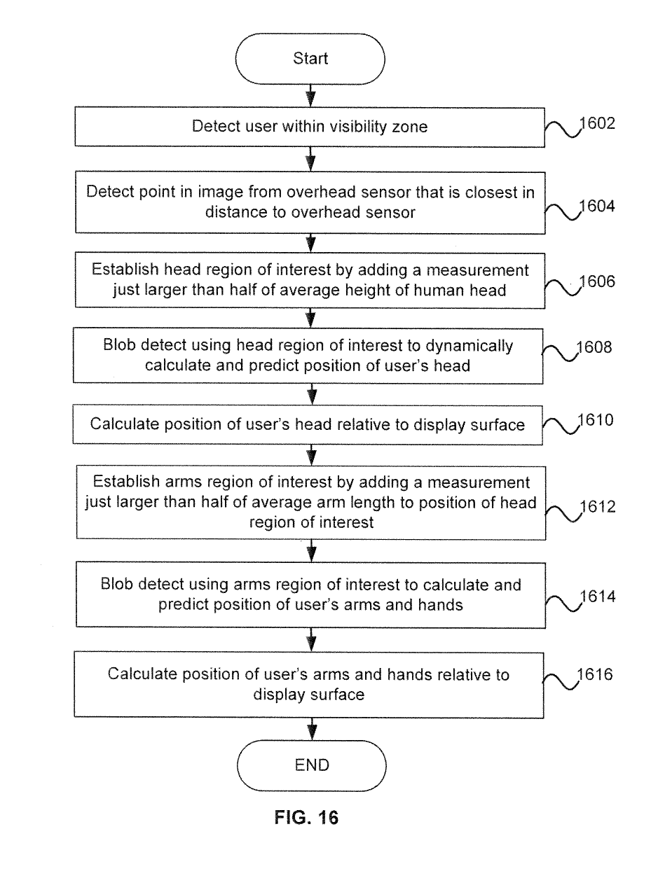

FIG. 16 is a flowchart of a method for determining a position of a user's head and arms in some embodiments. In some embodiments, an overhead sensor, such as a camera, detects a user within a visibility zone. The visibility zone is any zone that may be scanned by the overhead camera. In some embodiments, the overhead sensor sends information to a display and scans images and/or other information to determine a user within the zone.

In step 1604, the display and/or overhead camera detect a point in an image from the overhead sensor that is closest in distance to the overhead sensor. In some embodiments, the relative size of the object may be used to judge proximity of the point to the distance to the overhead sensor. In some embodiments, sensors in the display work with the overhead sensor to confirm that an object is closest in distance to the overhead sensor.

In step 1606, the head position module establishes a head region of interest based on the point in the image that is closest in distance to the overhead sensor and adding a measurement that is just larger than half of an average height of a human head. In some embodiments, other sensors detect the shoulders, chest, or arms of the user and the bottom of the head region of interest is defined based in part on the position of the shoulders, chest, or arms of the user.

In step 1608, the head position module may perform any recognition or detection (e.g., blob detection) within the head region of interest to dynamically calculate and predict a position of the user's head. The recognition or detection may be performed, for example, on an image or information from one or more sensors.

In step 1610, the head position module may calculate the position (e.g., a 2d or 3d position) of the user's head relative to a position of the display and/or the display surface. The viewpoint of the user may also be determined. In some embodiments, the virtual representation may depict an image that is relative to the user's head (e.g., a helmet or cockpit) such that the user may interact with the virtual representation.

In step 1612, the arms position module may establish an arms region of interest, based on input from the overhead sensor and/or one or more other sensors, by adding a measurement just larger than half of the average arm length to a position of the head region of interest. Those skilled in the art will appreciate that any distance may be added to the position of the head region of interest to define the arms region of interest.

In step 1614, the arms position module may use recognition and/or detection (e.g., blob detect) using an arms region of interest to calculate and predict a position of the user's aims and/or hands. Once the general and predicted positions of the aims and/or hands are determined, the arms position module may calculate the position, orientation, and direction of the arms and hands of the user relative to the display surface.

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

1. A method comprising:
generating a virtual representation of a non-virtual environment;
determining a position of a user relative to the display using an overhead sensor when the user is within a predetermined proximity to a display;
determining a position of a user's head relative to the display using the overhead sensor; and
displaying the virtual representation on the display in a spatial relationship with the non-virtual environment based on the position of the user's head relative to the display.

2. The method of claim 1, wherein determining the position of the user's head relative to the display using an overhead sensor comprises detecting the user and determining a z-depth between the overhead camera and a position closest to the overhead sensor.

3. The method of claim 2, further comprising adding ½ of the length of an average user's head to the position closest to the overhead sensor to define a head region of interest.

4. The method of claim 3, further comprising determining a position of the user head within the head region of interest.

5. The method of claim 4, adjusting the virtual representation to display an image over a position in the virtual representation that correlates with a position of the user's head using the head region of interest.

6. The method of claim 1, further comprising detecting the user and determining a z-depth between the overhead camera and the user's arms.

7. The method of claim 6, further comprising adding a length of an average user's aims to the bottom of the z-depth between the overhead camera and the user's arms to define an arms region of interest.

8. The method of claim 7, further comprising determining a position of a user's arms and hands in the arms region of interest.

9. The method of claim 8, further comprising adjusting the virtual representation to display an image over a position in the virtual representation that correlates with a position of the user's arms using the arms region of interest.

10. The method of claim 1, wherein the overhead sensor is a camera.

11. The method of claim 1, wherein determining the position of the user's head comprises interpolating between data from the overhead sensor relating to a position of the user's head and data from the first sensor relating to the position of the user's head.

12. A system comprising:
a display configured to display a virtual representation of a non-virtual environment;
an overhead sensor that scans an area in front of the display;
one or more display sensors coupled to the display; and
a processor configured to determine a position of a user relative to the display using the overhead sensor when the user is within a predetermined proximity to a display, determining a position of a user's head relative to the display using the overhead sensor, and displaying the virtual representation on the display in a spatial relationship with the non-virtual environment based on the position of the user's head relative to the display.

13. The system of claim 12, wherein the processor configured to determine the position of the user's head relative to the display using the overhead sensor comprises the processor configured to detect the user and determining a z-depth between the overhead camera and a position closest to the overhead sensor.

14. The system of claim 13, wherein the processor is further configured to add ½ of the length of an average user's head to the position closest to the overhead sensor to define a head region of interest.

15. The system of claim 14, wherein the processor is further configured to further comprising determining a position of the user head within the head region of interest.

16. The system of claim 15, wherein the processor is further configured to adjust the virtual representation to display an image over a position in the virtual representation that correlates with a position of the user's head using the head region of interest.

17. The system of claim 12, wherein the processor is further configured to detect the user and determining a z-depth between the overhead camera and the user's arms.

18. The system of claim 17, further comprising adding a length of an average user's arms to the bottom of the z-depth between the overhead camera and the user's arms to define an arms region of interest.

19. The system of claim 18, wherein the processor is further configured to determine a position of a user's arms and hands in the arms region of interest.

20. The system of claim 19, wherein the processor is further configured to adjust the virtual representation to display an image over a position in the virtual representation that correlates with a position of the user's arms using the arms region of interest.

21. The system of claim 12, wherein the overhead sensor is a camera.

22. The system of claim 12, wherein the processor configured to determine the position of the user's head comprises the processor configured to interpolate between data from the overhead sensor relating to a position of the user's head and data from the first sensor relating to the position of the user's head.

23. A computer readable medium configured to store executable instructions, the instructions being executable by a processor to perform a method, the method comprising:
generating a virtual representation of a non-virtual environment;
determining a position of a user relative to the display using an overhead sensor when the user is within a predetermined proximity to a display;
determining a position of a user's head relative to the display using the overhead sensor; and
displaying the virtual representation on the display in a spatial relationship with the non-virtual environment based on the position of the user's head relative to the display.
